(19) United States
(12) Patent Application Publication
(10) Pub. No.: US 2023/0214834 A1
(43) Pub. Date: Jul. 6, 2023

(54) SYSTEMS AND METHODS FOR CENTRALIZED AUTHENTICATION OF FINANCIAL TRANSACTIONS

(71) Applicant: Felix Payment Systems Ltd., Vancouver (CA)

(72) Inventors: Kieran MOLONEY, Vancouver (CA); Warren HOGG, Vancouver (CA); Sean DENNIS, Vancouver (CA); Owen NEWPORT, Vancouver (CA); Kim FLEURY BERTRAND, Vancouver (CA)

(21) Appl. No.: 17/996,200

(22) PCT Filed: May 7, 2021
(86) PCT No.: PCT/CA2021/050644

§ 371 Date: Oct. 13, 2022

Related U.S. Application Data
(60) Provisional application No. 63/022,231, filed on May 8, 2020.

(51) Int. Cl. G06Q 20/40; G06Q 20/02; G06Q 20/32

(52) U.S. Cl. CPC G06Q 20/4012; G06Q 20/40145; G06Q 20/027; G06Q 20/3223

(57) ABSTRACT

Disclosed are systems and methods for centralized authentication of financial transactions. An authentication server receives, from a client device, information for a financial transaction. In accordance with an embodiment of the disclosure, the authentication server executes in a kernel-based environment at least one authentication step based on the information. For example, in some implementations, the authentication server generates a PIN block and transmits the PIN block to a financial gateway, along with a request for the financial transaction. Notably, the client device does not need to perform the authentication steps executed by the authentication server, such as generating the PIN block for example. This can enhance security of the transaction system because information such as a terminal key used to generate the PIN block remains centralized and not on a client device where it could possibly be stolen by a criminal.

### RELATED APPLICATION

This patent application claims priority to U.S. Provisional Patent Application No. 63/022,231 filed on May 8, 2020, the entire disclosure of which is incorporated by reference.

### FIELD OF THE DISCLOSURE

This disclosure relates to communication systems, and more particularly to communication systems for financial transactions.

### BACKGROUND

Use of credit cards and debit cards for making purchases or other financial transactions using a POS (Point of Sale) device is commonplace in society. Use of such POS devices can be subjected to various standards such as PCI DSS (Payment Card Industry Data Security Standard), which is an information security standard created to increase controls around cardholder data and reduce credit card fraud. Various security features have been implemented to authenticate a financial transaction. As an example, when a user wants to make a purchase that has a price exceeding a given threshold, the POS device can prompt the user for a PIN (personal identification number) for authentication purposes. Upon receiving the PIN, the POS device generates a PIN block based on the PIN and additional information that can include a terminal key, a card certificate and sequencing information. The POS device then transmits the PIN block to a financial gateway, and the purchase is authorized by the financial gateway only if the PIN block is confirmed to be authentic.

Unfortunately, generation of the PIN block by the POS device introduces various security risks because information such as the terminal key is present on the POS device. For example, if a criminal were to modify firmware on the POS device, it may be possible for the criminal to not only obtain the PIN that has been entered by the user, but also other information such as the terminal key. In this manner, it may be possible for the criminal to use this information to generate another PIN block to make a fraudulent purchase, possibly leaving the user responsible for the fraudulent purchase. In addition, 3rd-party hacks to capture card and PIN data are possible as well. In this manner, authentication steps by the POS device such as generating the PIN block introduces some security risks and leaves much to be desired. Moreover, changing existing infrastructure would involve a lot of time and effort and hence is not be practical.

### SUMMARY OF THE DISCLOSURE

Disclosed are systems and methods for centralized authentication of financial transactions. A financial transaction system includes a client device, an authentication server, and a financial gateway. The authentication server receives, from the client device, information for a financial transaction. In accordance with an embodiment of the disclosure, the authentication server executes in a kernel-based environment at least one authentication step based on the information. For example, in some implementations, the authentication server generates a PIN block and transmits the PIN block to the financial gateway, along with a request for the financial transaction.

Notably, the client device does not need to perform the authentication steps executed by the authentication server, such as generating the PIN block for example. This can enhance security of the transaction system because information such as a terminal key used to generate the PIN block remains centralized and not on the client device where it may be less secure. As previously noted, information that is not centralized could be stolen by a criminal and used to make fraudulent transactions.

In addition, because the client device does not need to perform the authentication steps executed by the authentication server, the client device can be any suitably configured computing device such as a smartphone for example. The client device does not need to be a specific POS device with specialized firmware supporting a kernel-based environment. In this way, in addition to the enhanced security noted above, the financial transaction system can provide for enhanced flexibility by enabling users to easily perform financial transactions using their smartphone or another computing device. This could allow for widespread adoption.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of a financial transaction system including a client device, an authentication server, and a financial gateway;

FIG. 2 is a flowchart of a method for execution by an authentication server;

FIG. 3 through FIG. 10 are flowcharts of methods for processing a financial transaction in a financial transaction system;

FIG. 11 is a flowchart of a method for remote key injection;

FIG. 12 is a block diagram of example software architecture for an authentication server; and

FIG. 13 through FIG. 22 are sequence drawings showing example signaling and processing for a financial transaction system.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

### Introduction

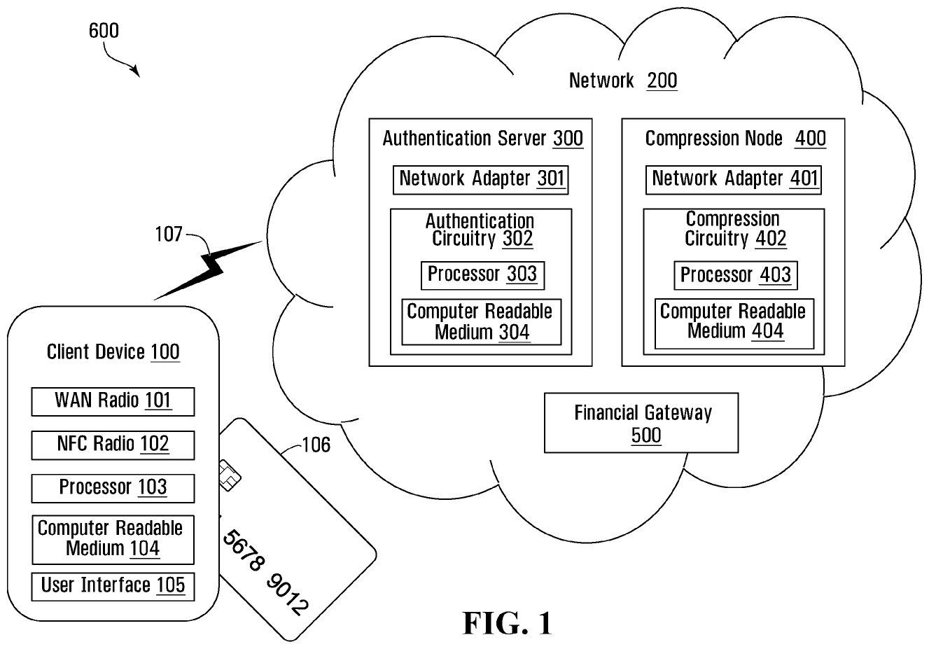

Referring first to FIG. 1, shown is a block diagram of a financial transaction system 600 including a client device 100, an authentication server 300, and a financial gateway 500. The authentication server 300 and the financial gateway 500 are part of a network 200, which can include several different networks even though such details are not shown for simplicity. For example, the network 200 can include a RAN (Radio Access Network) for communicating with wireless stations such as the client device 100, and an Internet for communicating with numerous computing devices. The financial gateway 500 can include a card network for a card issuer, a banking network, and other components as well, but these details are not shown for simplicity. In some implementations, as shown in the illustrated example, the network 200 also has a compression node 400, which can be integrated with the financial gateway 500, for example with a card network. The financial transaction system 600 can have other components as well, but these details are not shown for simplicity.

Operation of the financial transaction system 600 will now be described by way of example. In this example, a user of the client device 100 wishes to make a financial transaction such as a purchase using a credit card 106. When the credit card 106 is held close to the client device 100, the client device 100 is able to read card data from the credit card 106 using an NFC (Near-Field Communication) radio 102. The client device 100 is able to communicate with the network 200 over a wireless connection 107 using a WAN (Wide Area Network) radio 101. Such communication includes information for the financial transaction. Such information can include details of the financial transaction and the card data, and can also include personal identification data such as a PIN that has been entered via a user interface 105 for example.

The authentication server 300 has a network adapter 301 configured to receive the information for the financial transaction from the client device 100, authentication circuitry 302 coupled to the network adapter 301, and may have other components that are not specifically shown. The network adapter 401 can include multiple network adapters, for example a first network adapter for communicating with client devices such as the client device 100 and a second network adapter for communicating with the financial gateway 500, or a single network adapter.

In accordance with an embodiment of the disclosure, the authentication circuitry 302 is configured to execute in a kernel-based environment at least one authentication step based on the information from the client device 100. For example, in some implementations, if a PIN has been received the client device 100, the authentication circuitry 302 generates a PIN block based on the PIN and additional information that can include a terminal key, a card certificate and sequencing information. Furthermore, the authentication circuitry 302 transmits the PIN block to the financial gateway 500 via the network adapter 301, along with a request for the financial transaction. In some implementations, the financial transaction is authorized by the financial gateway 500 only if the PIN block is confirmed to be authentic. In some implementations, the authentication server 300 receives a result of the financial transaction (e.g. authorized or denied) from the financial gateway 500, and conveys that result to the client device 100.

In some implementations, the kernel-based environment of the authentication server 300 is a low-level abstraction layer that facilitates interactions between hardware and software components. The kernel-based environment of the authentication server 300 is used to execute at least one authentication step. In some implementations, the kernel-based environment provides protection from faults (fault tolerance) and from malicious behaviours (security). Thus, the at least one authentication step can be executed by the authentication server 300 with these protections. In some implementations, the kernel reads card requirements but overrides card requests to implement core authentication based on the implementation of the Kernel. Specific example details of the kernel-based environment are described later for a “Hector” implementation. Other implementations are possible and are within the scope of the disclosure.

Notably, the client device 100 does not need to perform the authentication steps executed by the authentication server 300, such as generating the PIN block for example. This can enhance security of the transaction system 600 because information such as the terminal key used to generate the PIN block can remain centralized in the network 200 and not on the client device 100 where it may be less secure. As previously noted, information that is not centralized (e.g. terminal key) could be stolen by a criminal and used to make fraudulent transactions. In some implementations, the client device 100 is classified as a “dumb” terminal because all logic and determination of CVM (Cardholder Verification Methods) are done in the cloud, especially by the authentication server 300.

In addition, because the client device 100 does not need to perform the authentication steps executed by the authentication server 300, the client device 100 can be any suitably configured computing device such as a smartphone for example. The client device 100 does not need to be a specific POS device with specialized firmware supporting a kernel-based environment. In this way, in addition to the enhanced security noted above, the financial transaction system 600 can provide for enhanced flexibility by enabling users to easily perform financial transactions using their smartphone or any other suitable computing device. This could allow for widespread adoption.

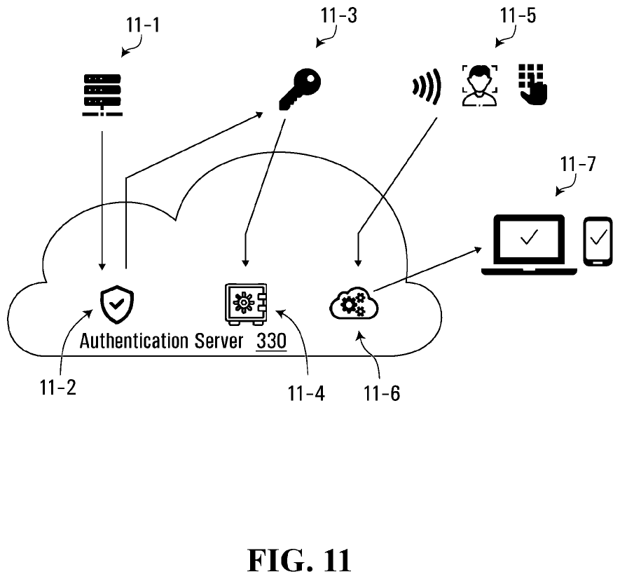

Although the financial transaction system 600 is shown with one client device 100, it is to be understood that numerous client devices can be present. More than one of these client devices can belong to the same user of the client device 100. In other words, the user of the client device 100 can operate a plurality of client devices (including the client device 100) in the financial transaction system 600. Note that none of the plurality of client devices store the terminal key used to generate the PIN block. Rather, the terminal key is stored on the authentication server 300 and can be used for all of the client devices of the same user. In this way, the terminal key can be used with many endpoints, which is different from existing systems in which each POS device has its own unique terminal key. In some implementations, the terminal key is generated by an Eso server and remotely “injected” into the financial transaction system 600 for storage on the authentication server 300. This remote injection can be provided by a third party, for example Geobridge. Specific example details of remote key injection are provided below with reference to FIG. 11. Note that the authentication server 300 would store different terminal keys for different users.

Note that the authentication server 300 can perform authentication steps for numerous client devices in a centralized and unified manner. While existing systems may support numerous POS devices, each POS device uses specialized firmware supporting a kernel-based environment for performing authentication steps. The existing systems already have several (e.g. nine) different kernels for different POS devices, and deployment of new POS devices can be arduous and time-consuming because there can be several certification levels (e.g. level one certification for hardware, level two certification for kernel, and level three certification for card brand), which can for example take about 24 to 36 months to complete. By contrast, the kernel-based environment of the authentication server 300 is one unified environment that can be used with numerous client devices without any specialized firmware for the client devices and without having to go through the certification levels for the client devices.

There are many possibilities for the client device 100, especially since the client device 100 does not need to be a specific POS device with specialized firmware supporting a kernel-based environment. In some implementations, the client device 100 is a smartphone configured to communicate with the credit card 106 using the NFC radio 102 and to communicate with the network 200 using the WAN radio 102. However, other implementations are possible for the client device 100. In other implementations, the client device 100 is a desktop computer, a laptop computer, a tablet computer, or any other suitable client device. For such implementations, there may be no NFC radio in which case a user may manually enter card data through a user interface, and there may be no WAN radio in which case a user may connect to the network 200 through other means, such as a wired connection for example.

In some implementations, operation of the client device 100 is software implemented with a processor 103 running software, which can stem from a computer readable medium 104 and/or downloaded from the network 200. However, other implementations are possible and are within the scope of this disclosure.

In some implementations, the authentication circuitry 302 of the authentication server 300 includes a processor 303 running software, which can stem from a computer readable medium 304. However, other implementations are possible and are within the scope of this disclosure. Other implementations can include additional or alternative hardware components, such as any appropriately configured FPGA (Field-Programmable Gate Array), ASIC (Application-Specific Integrated Circuit), and/or microcontroller, for example. More generally, the authentication circuitry 302 of the authentication server 300 can be implemented with any suitable combination of hardware, software and/or firmware.

According to another embodiment of the disclosure, there is provided a non-transitory computer readable medium having recorded thereon statements and instructions that, when executed by a processor of an authentication server, implement a method as described herein. In some implementations, the non-transitory computer readable medium is the computer readable medium 304 of the authentication server 300 shown in FIG. 1. There are many possibilities for the non-transitory computer readable medium. Some possibilities include an SSD (Solid State Drive), a hard disk drive, a CD (Compact Disc), a DVD (Digital Video Disc), a BD (Blu-ray Disc), a memory stick, or any appropriate combination thereof.

In the example described above, the user provides the PIN via the user interface 105, and the PIN is provided to the authentication server 300 so that the authentication circuitry 302 can generate the PIN block and transmit the PIN block to the financial gateway. However, it is to be understood that these are very specific authentication steps and that other authentication steps can be performed by the authentication server 300 instead of, or in addition to, those described above. Further details are provided below.

### Method for Authentication

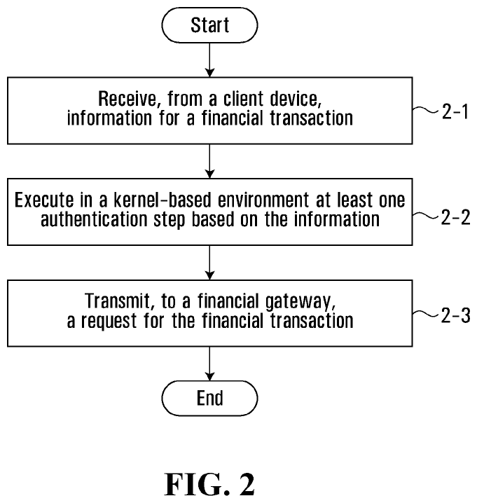

Turning now to FIG. 2, shown is a flowchart of a method for execution by an authentication server, for example by the authentication circuitry 302 of the authentication server 300 shown in FIG. 1. The method of FIG. 2 is described below with reference to the financial transaction system 600 of FIG. 1. However, it is to be understood that the method of FIG. 2 is applicable to other financial transaction systems.

At step 2-1, the authentication server 300 receives, from the client device 100, information for a financial transaction. At step 2-2, in accordance with an embodiment of the disclosure, the authentication server 300 executes in a kernel-based environment at least one authentication step based on the information. For example, in some implementations, the authentication server 300 generates a PIN block based on a PIN received from the client device 100. Finally, at step 2-3, the authentication server 300 transmits, to the financial gateway 500, a request for the financial transaction. In the example in which the PIN block has been generated, the authentication server 300 also transmits the PIN block to the financial gateway 500, and the financial transaction is authorized by the financial gateway 500 only if the PIN block is confirmed to be authentic.

Notably, the client device 100 does not need to perform the authentication steps executed by the authentication server 300, such as generating the PIN block for example. As previously explained, this can enhance security and flexibility for users.

In some implementations, the information received from the client device 100 includes personal identification data, and the at least one authentication step executed by the authentication server 300 includes generating a personal identification block based on the personal identification data and additional information, and transmitting the personal identification block to the financial gateway 500.

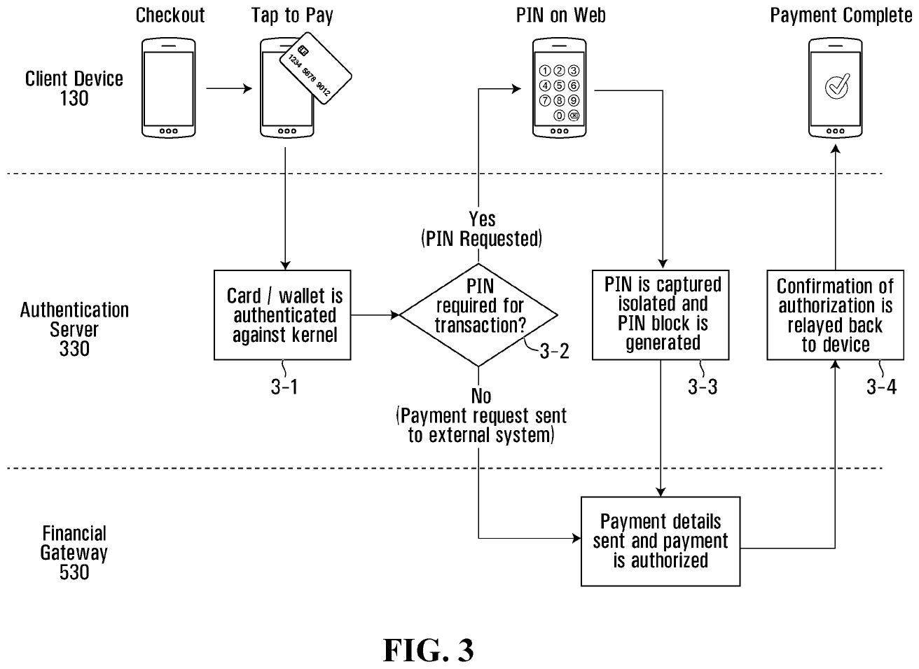

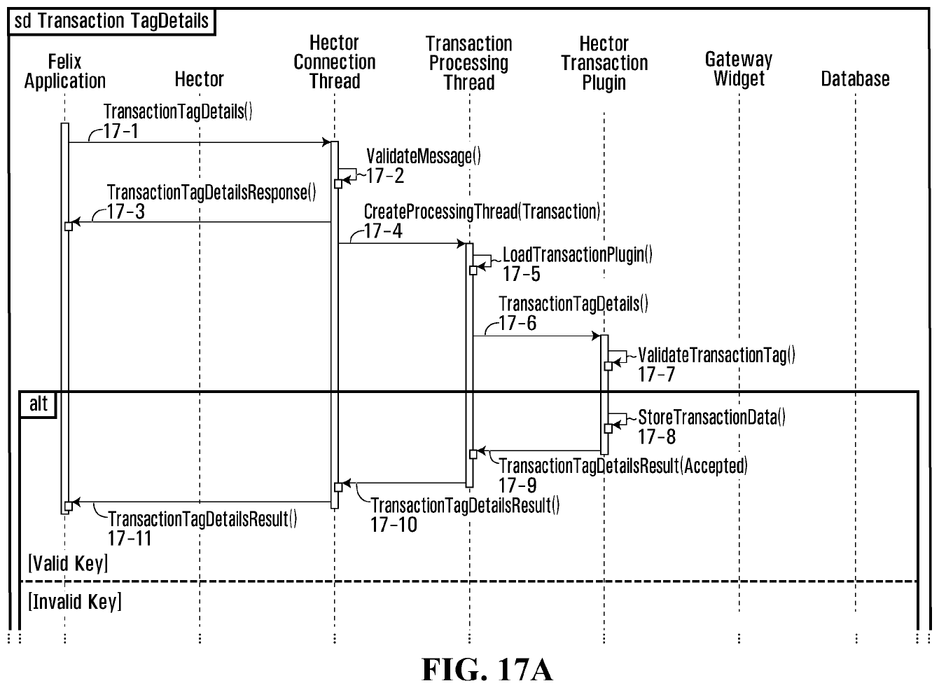

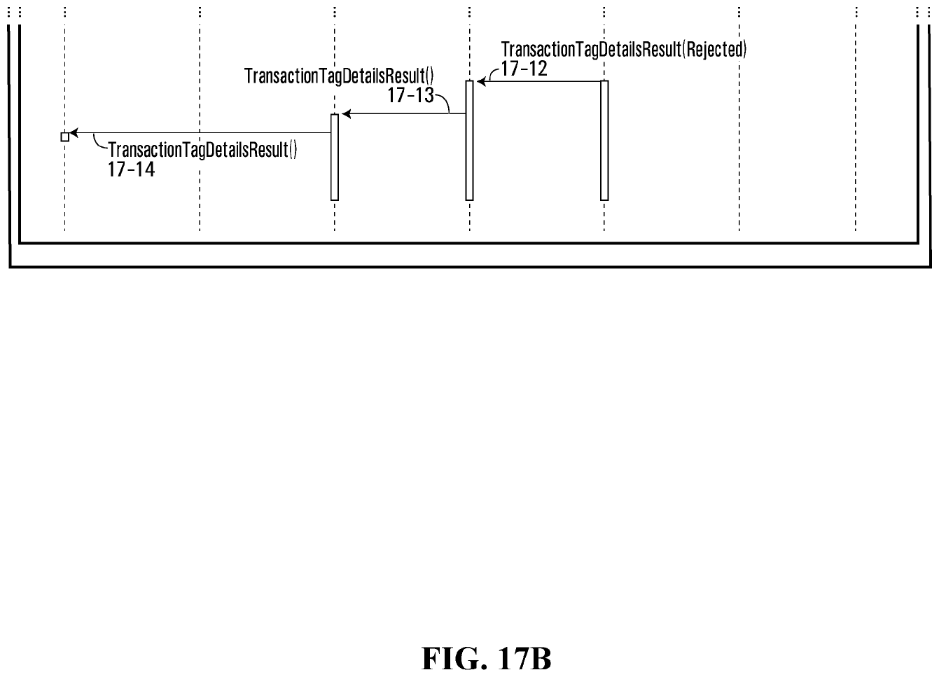

In some implementations, the personal identification data is a PIN and the personal identification block is a PIN block. For specific examples, see FIG. 3 and FIG. 6 through FIG. 10. Also see FIG. 17 for specific example signaling and processing. In some implementations, the PIN is a four-digit number that has been predefined by a user. In other implementations, the PIN is a six-digit number that has been predefined by a user. Other implementations are possible.

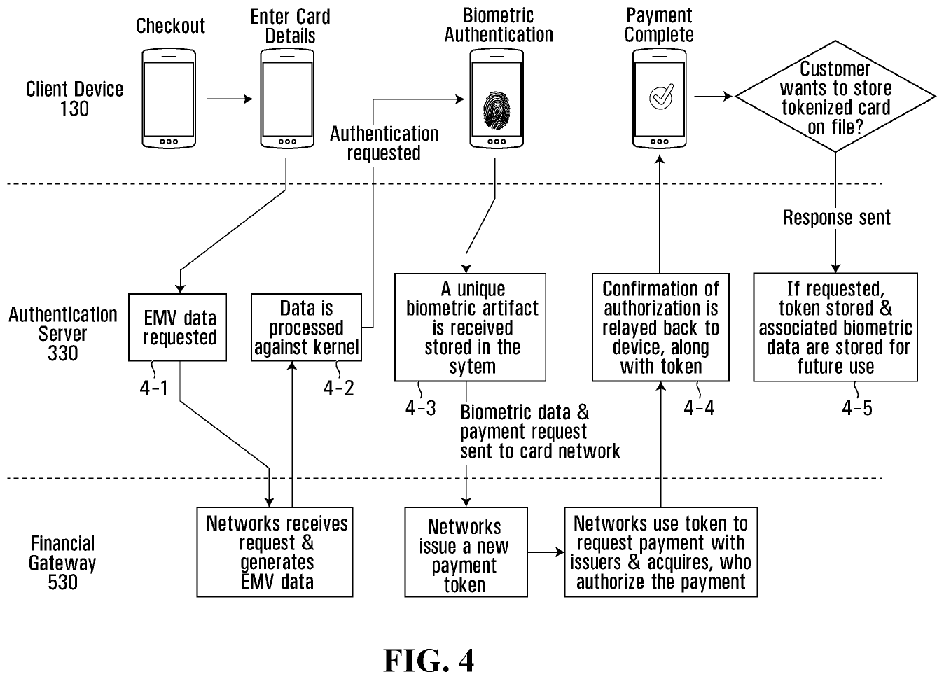

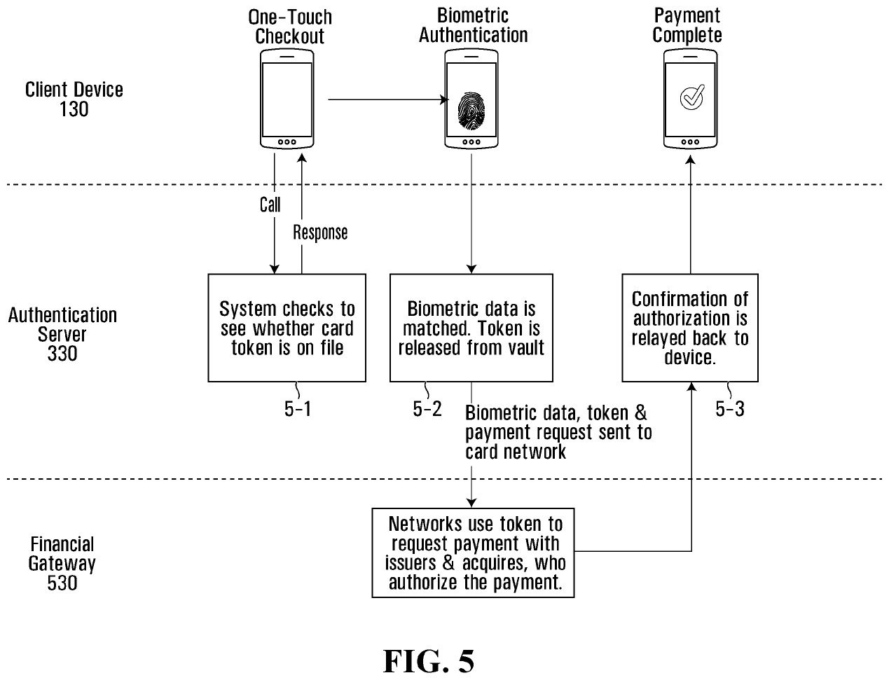

In other implementations, the personal identification data is biometric data, and the personal identification block is a biometric block. For specific examples, see FIG. 4 and FIG. 5. Signaling and processing would be similar to that shown in FIG. 17. In some implementations, the biometric data includes fingerprint data that has been generated by a finger scanner. In other implementations, the biometric data includes eye/iris data that has been generated by an eye scanner. Other implementations are possible.

In some implementations, the authentication server 300 requests the personal identification data from the client device 100. In some implementations, the authentication server 300 requests the personal identification data from the client device 100 depending on some criteria, for example a purchase price exceeding a given threshold such as $100 for example. In some implementations, the authentication server 300 requests biometric data instead of a PIN when available, because biometric data may be more secure than a PIN. For example, upon the authentication server 300 determining that the client device 100 is biometric ready with saved biometrics, the authentication server 300 can request biometric data. Otherwise, the authentication server 300 can consider whether to use a PIN, for example by assessing whether card data contains a sequence indicating that a PIN is available. In other implementations, the authentication server 300 gives an option of using either biometric data or a PIN when both options are available. In some implementations, the authentication server 300 requests a signature if neither biometric data nor a PIN is available. In some jurisdictions such as the United States, it is possible that neither biometric data nor a PIN is available, in which case a signature may be requested.

In some implementations, the request for the financial transaction and the personal identification block (e.g. PIN block or biometric block) are transmitted together in a single message. In some implementations, the single message includes details of the financial transaction and the card data, in addition to the personal identification block and the request for the financial transaction. In other implementations, information is sent in separate messages. For example, in some implementations, the request for the financial transaction and the personal identification block are transmitted separately.

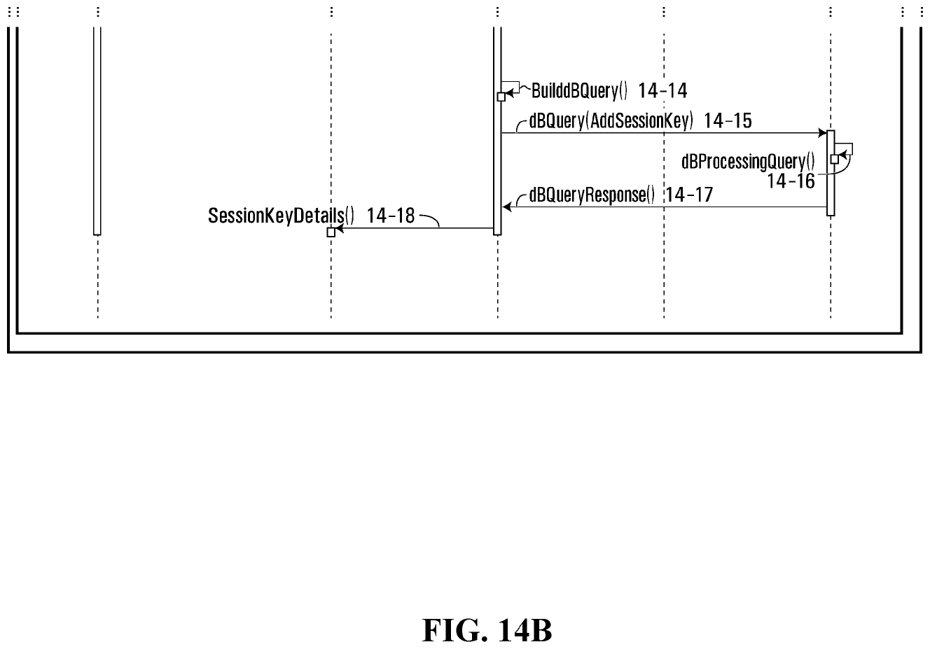

In some implementations, the additional information for the personal identification block includes a terminal key. In some implementations, the terminal key is retrieved from a database using user login details that are supplied by the client device 100 after the user has entered the user login details via the user interface 105 for example. See FIG. 14 for specific example details of retrieving a terminal key. In some implementations, the database is stored on a separate server (i.e. the database is not located on the authentication server 300). In some implementations, the database resides on a secure server of the network 200 and can hold terminal keys on behalf of numerous client devices.

In some implementations, the additional information for the personal identification block also includes a card certificate and sequencing information. In some implementations, the authentication server 300 acquires the card certificate from a card issuer via the financial gateway 500, and generates the sequencing information. The sequencing information indicates an order/sequence of information in the personal identification block, and can be generated based on a dynamic cryptogram obtained from the card data, for example.

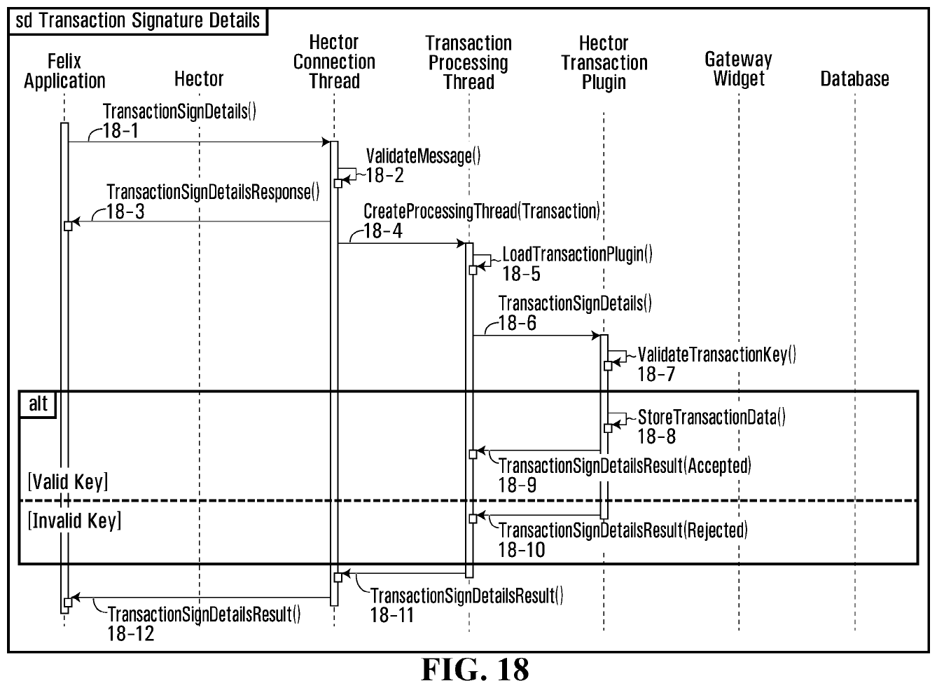

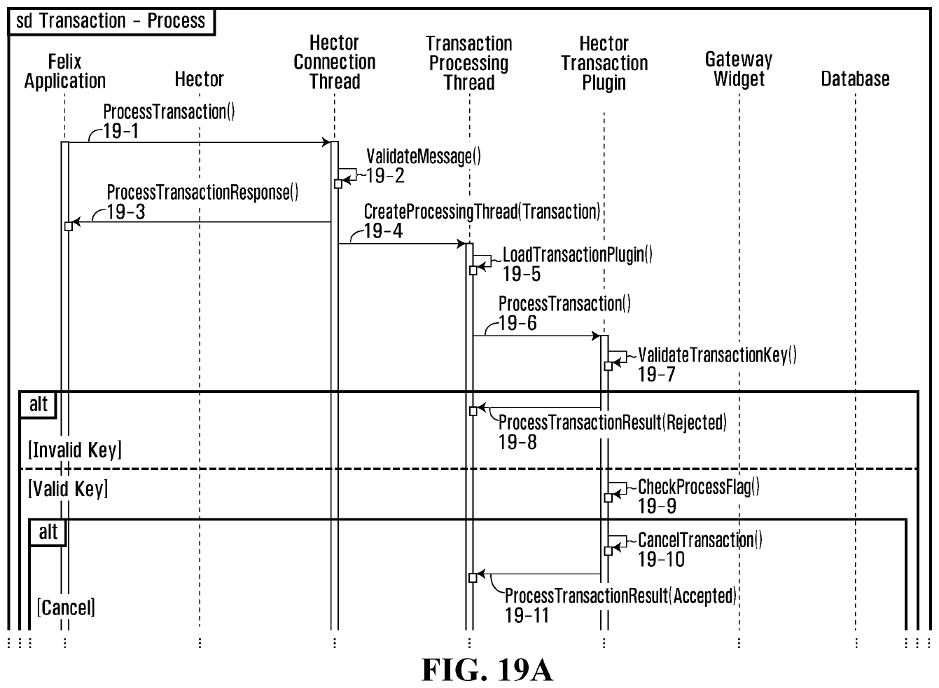

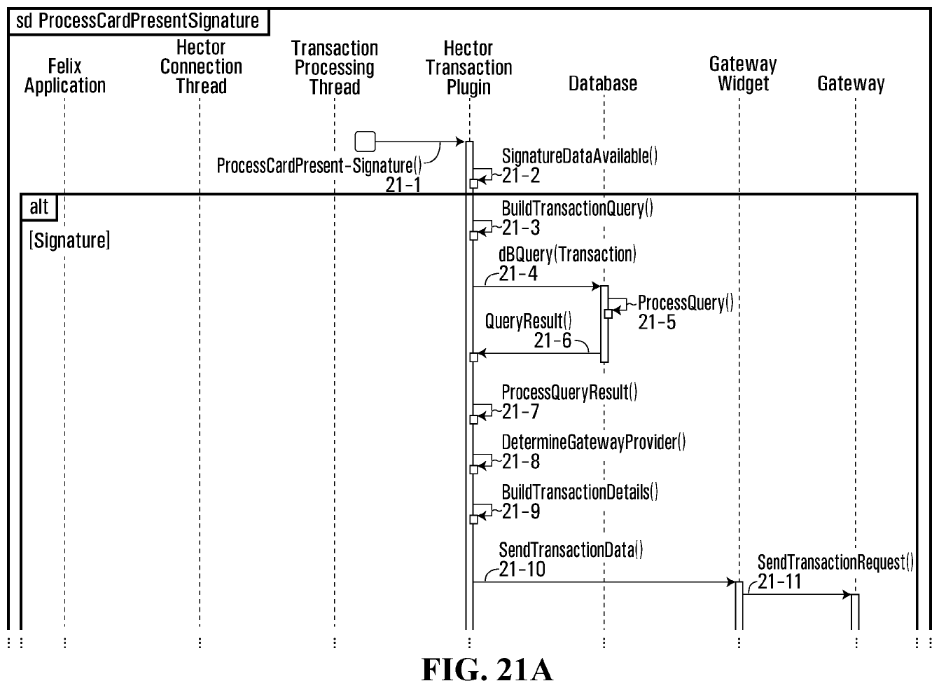

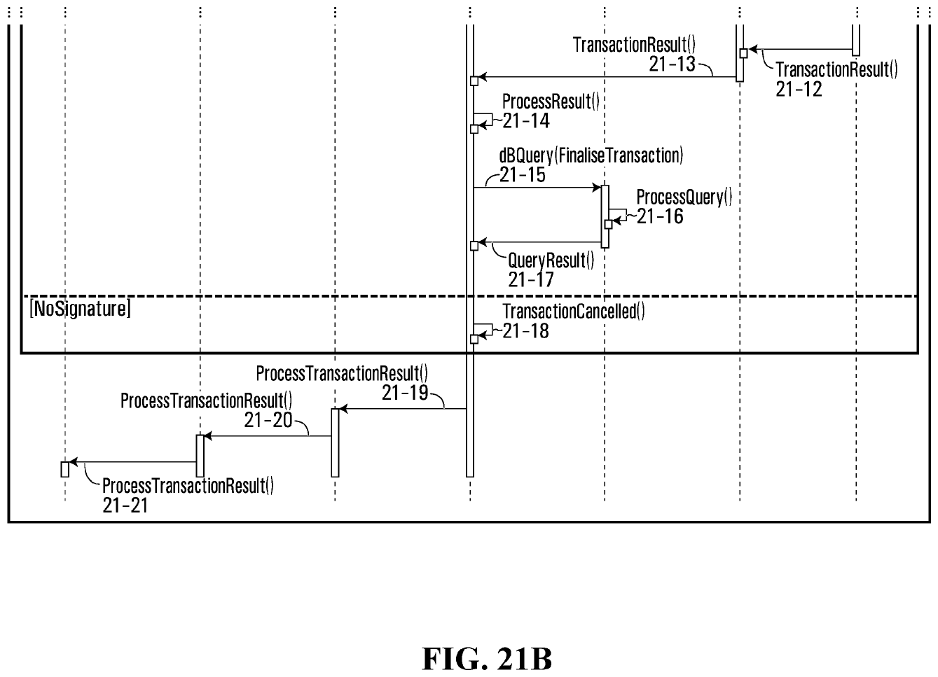

If no personal identification data (e.g. PIN or biometric data) is available or supported, then no personal identification block is generated by the authentication server 300. In such cases, the authentication server 300 can execute some other authentication step, for example EMV (Europay, Mastercard and Visa) authentication as described below. In addition, the authentication server 300 can request a signature. See FIG. 18 and FIG. 21 for specific example signaling and processing. However, a signature is not normally authenticated, but rather is stored so that it may be later reviewed in the event that a financial transaction is disputed. Hence, the authentication server 300 must still perform some other authentication step such as EMV authentication for example.

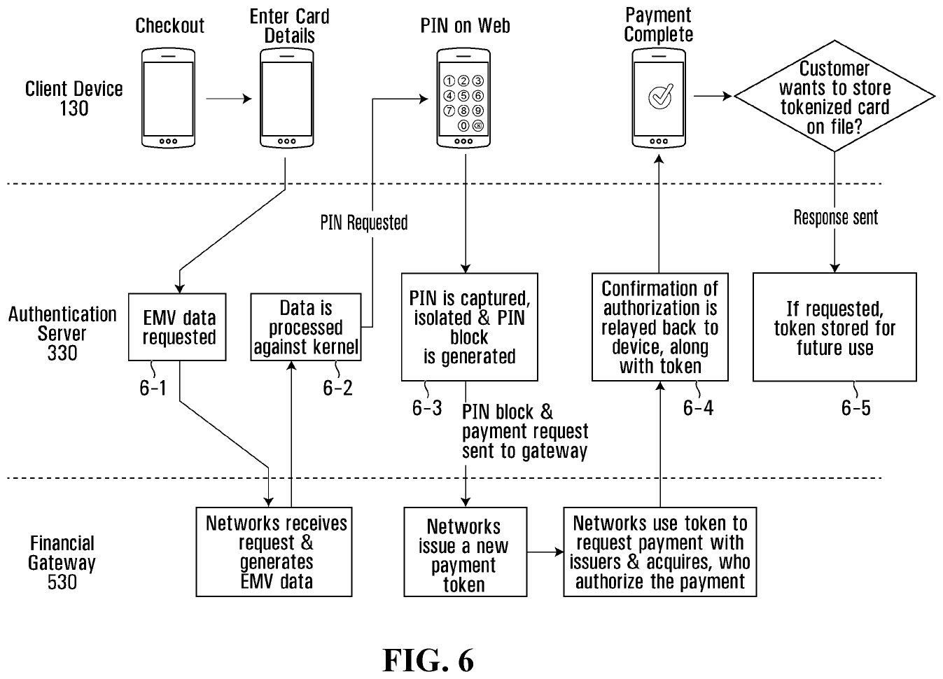

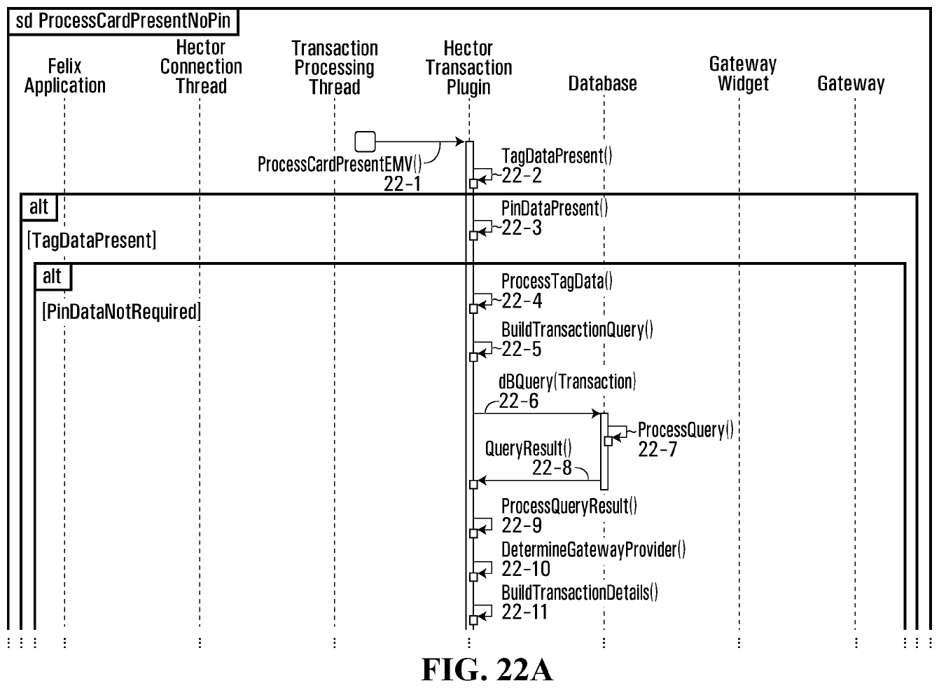

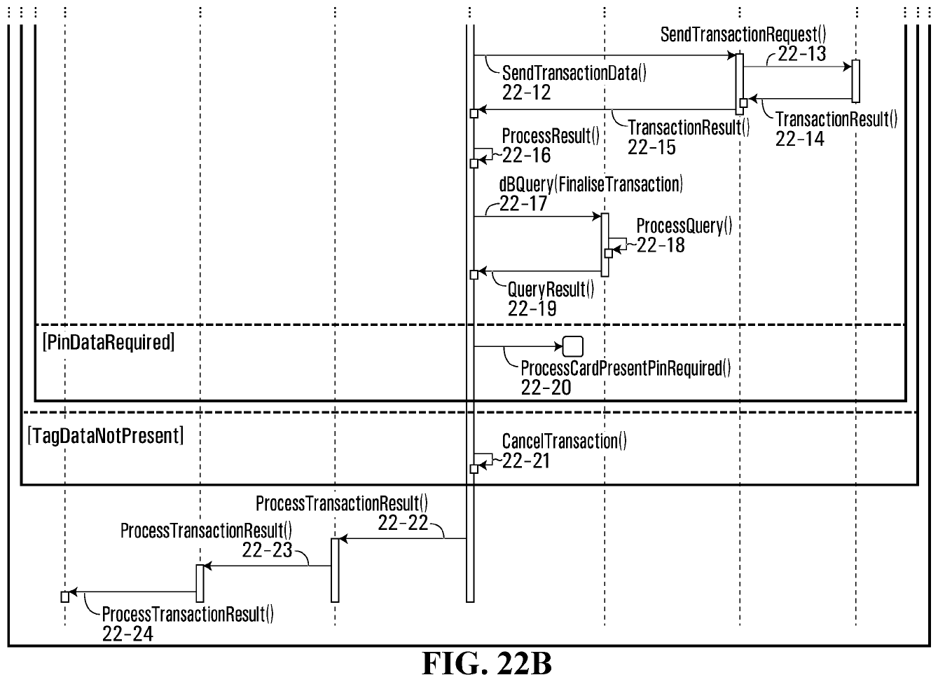

In some implementations, the information received from the client device 100 includes card data, and the at least one authentication step executed by the authentication server 300 includes sending the card data to the financial gateway 500, receiving EMV data from the financial gateway 500 responsive to the card data, and processing the EMV data and authenticating the EMV data using the terminal key. In some implementations, the information from the EMV data used for the authentication includes a cardholder verification EMV tag data set plus a dynamic EMV cryptogram. For specific examples of the EMV authentication, see FIG. 4 and FIG. 6. Also see FIG. 22 for specific example signaling and processing.

In some implementations, the EMV authentication is executed prior to generating and transmitting a personal identification block (e.g. PIN block or biometric block). In other implementations, the EMV authentication is executed after generating and transmitting a personal identification block (e.g. PIN block or biometric block). In other implementations, the EMV authentication is executed instead of generating and transmitting a personal identification block (e.g. PIN block or biometric block).

The EMV data as issued by the financial gateway 500 can be relatively large, for example 52 MB. Notably, in addition to the information used by the authentication server 300 for the authentication, the EMV data can include additional information that is not actually needed for the authentication, such as details of fifty previous transactions by the user for example. This additional information significantly contributes to the relatively large size of the EMV data. There is limited bandwidth between the financial gateway 500 and the authentication server 300, so the relatively large size of the EMV data can result in a relatively long delay before the EMV data is received by the authentication server 300, thereby increasing total time for processing and authorizing the financial transaction. A user may not want to wait more than a few seconds for the financial transaction to be processed and authorized. While it may be possible to remove at least some of the additional information such as the details of previous transactions, issuing banks will not likely comply.

Therefore, in accordance with another embodiment of the disclosure, the network 200 has a compression node 400 that operates to compress the EMV data to produce compressed EMV data and to transmit the compressed EMV data to the authentication server 300. The compression node 400 can be integrated with the financial gateway 500, for example with a card network, such that the compression node 400 can receive the EMV data relatively quickly. Although bandwidth to the authentication server 300 is limited, the relatively small size of the compressed EMV data enables the compressed EMV data to be received by the authentication server 300 relatively quickly.

In some implementations, the compression node 400 transmits the compressed EMV data in an order starting with the information used by the authentication server 300 for the authentication and followed by the additional information that is not actually needed for the authentication. The information transmitted first can for example include EMV card aid (e.g. PSP e-card and issuer bank), EMV card track (e.g. cardholder information and cryptographic info), and/or EMV dynamic data (e.g. card certificate infrastructure info and cardholder verification method), which can be used by the authentication server 300 for authentication purposes. The information transmitted last can for example include details of previous transactions, which is not actually needed for the authentication. In some implementations, XML (Extensible Markup Language) is used for ordering the compressed EMV data, for example based on determination and drive by a state controller fueled by security logic in the cloud.

In some implementations, the compression node 400 determines an order for the compressed EMV data by prioritizing the information used by the authentication server 300 for the authentication to be transmitted first. By performing such prioritization, it is possible for the authentication server 300 to start receiving and processing the information used for authentication before the additional data is even received, thereby expediting the processing. As a result of the EMV data being compressed and being ordered such that most useful information is received first, the financial transaction might be processed and authorized in about 1.25 seconds, for example. By contrast, without the compression node 400 to compress and order the EMV data, the financial transaction might be processed and authorized in about 30 seconds to 60 seconds, for example. Therefore, the combination of compressing the EMV data and ordering the compressed EMV data as described above can result in a significant reduction of time for authorizing a financial transaction.

The compression node 400 has a network adapter 401 configured to receive the EMV data and to transmit the compressed EMV data. The network adapter 401 can include multiple network adapters, for example a first network adapter for receiving the EMV data and a second network adapter for transmitting the compressed EMV data, or a single network adapter. The compression node 400 also has compression circuitry 402 configured to compress the EMV data to produce the compressed EMV data.

In some implementations, the compression circuitry 402 of the compression node 400 includes a processor 403 running software, which can stem from a computer readable medium 404. However, other implementations are possible and are within the scope of this disclosure. Hardware implementations can include any appropriately configured FPGA, ASIC, and/or microcontroller, for example, and may be devoid of any software. More generally, the compression circuitry 402 of the compression node 400 can be implemented with any suitable combination of hardware, software and/or firmware.

According to another embodiment of the disclosure, there is provided a non-transitory computer readable medium having recorded thereon statements and instructions that, when executed by a processor of a compression node, implement a method as described herein. In some implementations, the non-transitory computer readable medium is the computer readable medium 404 of the compression node 400 shown in FIG. 1. There are many possibilities for the non-transitory computer readable medium. Some possibilities include an SSD, a hard disk drive, a CD, a DVD, a BD, a memory stick, or any appropriate combination thereof.

The compression node 400 is shown to operate in combination with the authentication server 300. However, in another embodiment, the compression node 400 operates without the authentication server 300. For example, the compression node 400 can compress EMV data to produce compressed EMV data, and provide the compressed EMV data to a client device, such that the client device can perform an authentication step using the compressed EMV data.

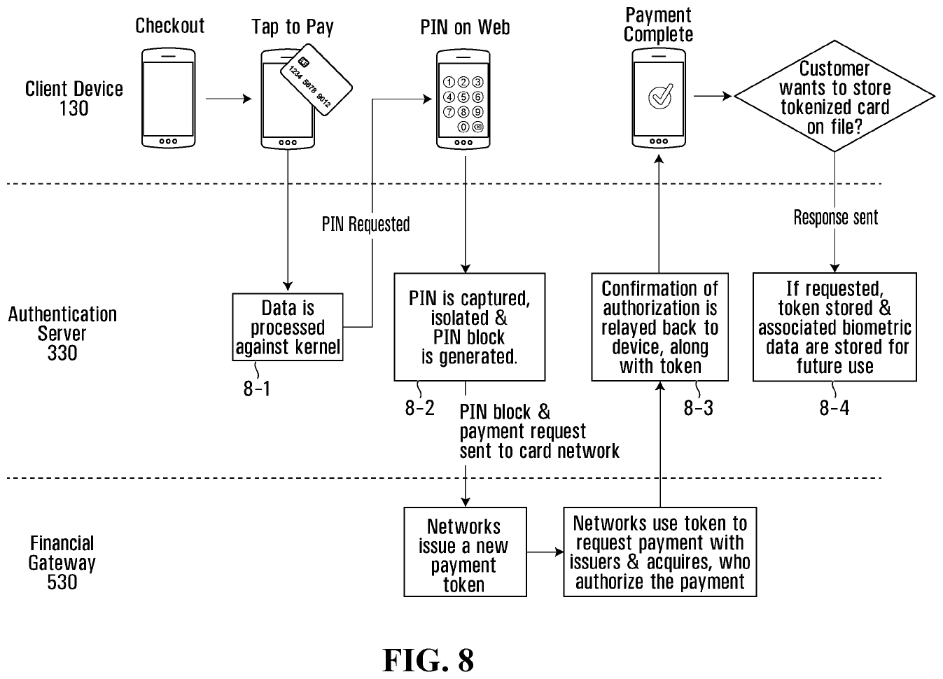

In some implementations, a card issuer generates a token based on the card data, and provides the token to the authentication server 300. In some implementations, the authentication server 300 provides the client device 100 with an option to store the token for future use. The token can be stored in a vault of the card issuer for future use such that, for a subsequent transaction, the client device 100 may not need to supply the card data again. For specific examples of how a token can be generated and stored for future use, see FIG. 4, FIG. 6, and FIG. 8.

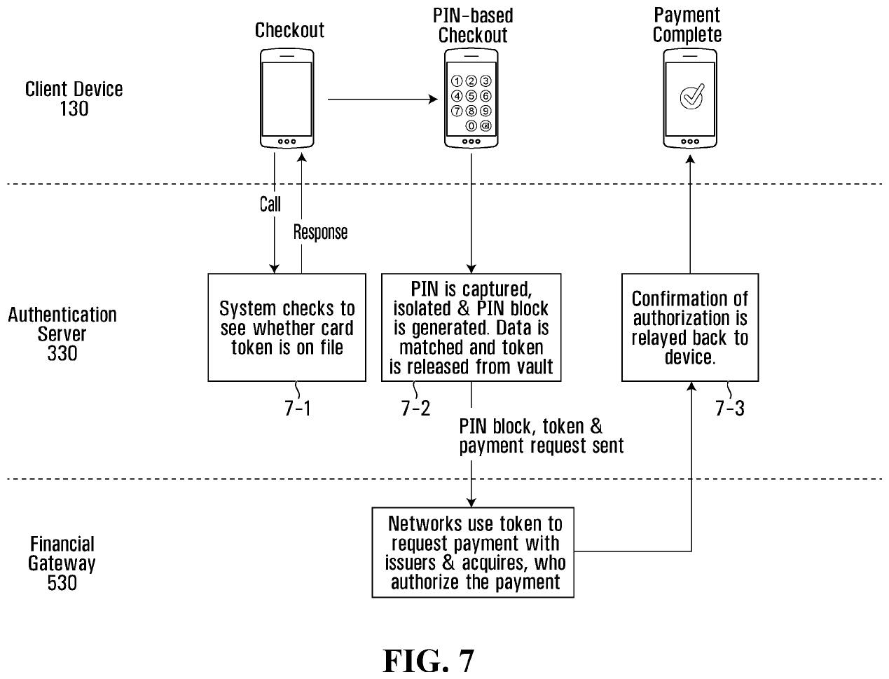

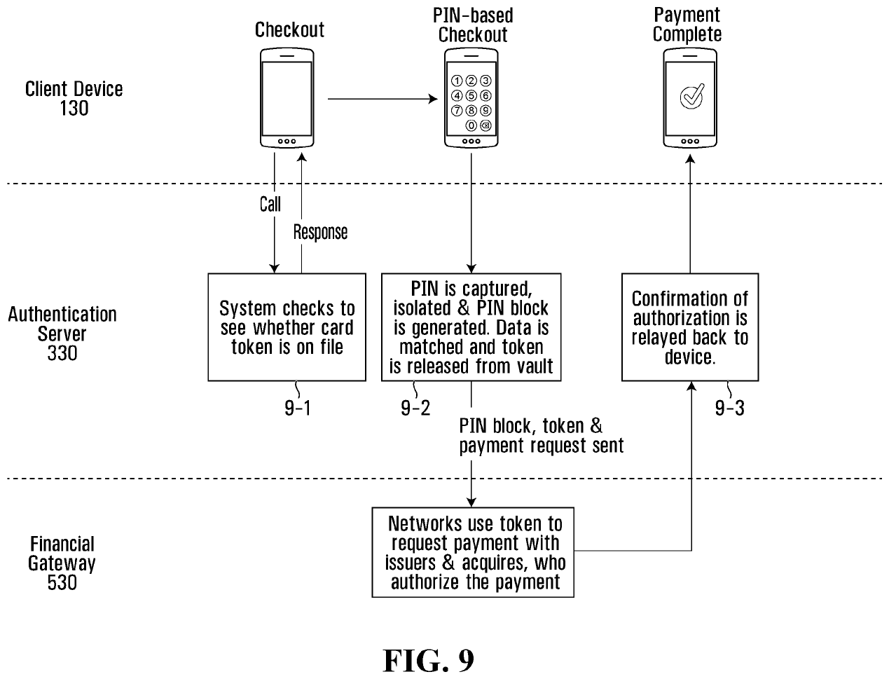

In some implementations, upon matching user login data for a subsequent transaction, the authentication server 300 releases and obtains the token from the vault, and transmits the token to the financial gateway 500. In this way, the client device 100 may not need to supply the card data again. This is because the token includes the card data. For specific examples of how a token may be released and utilized, see FIG. 5, FIG. 7 and FIG. 9. In some implementations, a request for the subsequent financial transaction, a personal identification block, and the token are all transmitted together in a single message. In other implementations, information is sent in separate messages.

In some implementations, a unique encryption key is used to verify that the client device 100 may operate with the authentication server 300. In some implementations, the authentication server 300 generates the unique encryption key, stores a first part of the unique encryption key on the client device 100, and stores a second part of the unique encryption key on the authentication server 300. Upon use of the client device 100, the authentication server 300 looks for the unique encryption key, decrypts, and validates the points. If successful, the authentication server 300 can rebuild the unique encryption key with a new set of points and place back onto the client device 100. This unique encryption key is checked and cycled each time the client device 100 performs a financial transaction. This ultimately enables the authentication server 300 to remotely monitor the client device 100 for attestation as well as cloning the application and software. If unsuccessful, the authentication server 300 will disconnect the client device 100 from itself and alert the user.

There are many ways for the unique encryption key to be generated. In some implementations, the client device 100 captures up to about thirty points of data, the authentication server 300 randomly selects some of these data points (e.g. a combination of seven of the data points) and generates the unique encryption key based on these data points. Note that the data points that are selected are not visible to any backend user, thereby preventing internal and external parties from manipulating the transaction flow process. Possible data points can include a unique footprint, a MAC (media access control) address, a geolocation, an IMEI (International Mobile Equipment Identity) number, a device unique ID, a device serial number, a Bluetooth adapter address, a SIM (Subscriber Identity Module) number if present, a network identifier, a software build OS e.g. Windows, Linux, ios, Android etc., a model, a build number, a release date, a merchant ID, a verification ID (one time random sequence generated by the authentication server 300), a hardware certification number, a device authentication key, a checksum software value, a device account, a device brand, a device firmware build date, a device firmware update date, etc.

### Transaction Processing

With reference to FIG. 3 through FIG. 10, shown are flowcharts of methods for processing a financial transaction in a financial transaction system. It is also noted that, similar to FIG. 1 and FIG. 2 described above, FIG. 3 through FIG. 10 involve a client device 130, an authentication server 330, and a financial gateway 530 (e.g. gateway, processor, card network or VISA/MasterCard). FIG. 3 through FIG. 10 show example details of signaling and processing similar to what has been described above for FIG. 1 and FIG. 2. It is to be understood that FIG. 3 through FIG. 10 are very specific and are provided merely for illustrative purposes, and that other embodiments are possible and within the scope of this disclosure.

FIG. 3 shows an example of processing a financial transaction using a software-based POS device and authentication using a PIN. A financial transaction is initiated by a user with a web-based NFC/PIN online checkout. The user selects to pay and initiates a web-based NFC payment via web browser by holding their card against their client device 130, which is NFC-enabled. Information for the financial transaction (e.g. card data and purchase price) is then provided to the authentication server 330. Upon receiving that information, at step 3-1 the authentication server 330 authenticates the card or wallet against a kernel.

At step 3-2, the authentication server 330 determines whether a PIN is required for the financial transaction. A PIN may be required depending on some criteria, for example the purchase price exceeding a given threshold such as $100 for example. If the authentication server 330 determines that a PIN is not required, then a payment request is sent to the financial gateway 530. However, if the authentication server 330 determines that a PIN is required, then a request is sent to the client device 130, and the user can respond by entering a PIN, for example using a touchscreen of the client device 130, and the PIN is then sent to the authentication server 330.

At step 3-3, the authentication server 330 captures and isolates the PIN, generates a PIN block based on the PIN, and sends the PIN block to the financial gateway 530 (e.g. Gateway, processor, card network) along with a payment request. The financial transaction is authorized by the financial gateway 530 if the PIN block is authentic. After the payment request has been processed by the financial gateway 530, at step 3-4 the authentication server 330 receives a result of the payment request and relays that result to the client device 130. In this case, the result of the payment request is a confirmation of authorization, and hence the client device 130 can provide an indication to the user that payment is complete.

Notably, the client device 130 does not need to perform the authentication steps by the authentication server 330, such as authenticating the card or wallet against the kernel (i.e. step 3-1) and generating and transmitting the PIN block (i.e. step 3-3). As previously explained, this can enhance security and flexibility for users.

The Example depicted in FIG. 3 involves tap to pay with NFC to obtain card data. In other implementations, rather than obtaining card data using tap to pay with NFC, card data can be manually entered by the user, for example using a touchscreen of the client device 130. The user can for example enter EMV data, and the EMV data is passed along to a card present module. Note that information for the financial transaction (e.g. card data and purchase price) would still be provided to the authentication server 330, and the authentication server 330 would still authenticate the card or wallet against the kernel. Thus, step 3-1 (and subsequent steps as well) would be executed in the same way.

FIG. 4 shows an example of processing a first financial transaction using manual entry of card data and authentication using biometric data, with a token storage process. A user selects to pay and enters card data, which is sent to the authentication server 330. At step 4-1, the authentication server 330 sends a request for EMV data along with the card data to the financial gateway 530 (e.g. VISA/MasterCard), which responds by generating EMV data and returning the same to the authentication server 330. At step 4-2, after the authentication server 330 receives the EMV data from the financial gateway 530 (e.g. issue bank), the authentication server 330 processes and authenticates the EMV data against a kernel using a terminal key. Furthermore, the authentication server 330 sends a request for authentication to the client device 130.

Authentication involves the user holding their fingerprint against the client device 130. The client device 130 obtains biometric data and sends the same to the authentication server 330 (e.g. 3rd party biometric engines such as facial recognition platforms). At step 4-3, the authentication server 330 receives the biometric data, generates a biometric block using the biometric data, and sends the biometric block along with a request for the first financial transaction. At step 4-3, the authentication server 330 receives the request and the biometric block, and stores a unique biometric artifact. Furthermore, the authentication server 330 sends a payment request along with biometric data to a card network of the financial gateway 530. In response, the card network generates and issues a token based on the card data. The token is used by networks to request payment with issuers and to determine who authorized payment. The first financial transaction is authorized by the financial gateway 530 if the biometric block is authentic in which case confirmation of authorization and the token are sent to the authentication server 330.

At step 4-4, upon receiving the confirmation of authorization and the token, the authentication server 330 relays the same to the client device 130. At this point, the client device 130 can provide an indication to the user that payment is complete. If the user agrees to store the token for future use, then a response is sent to the authentication server 330. Upon receipt of the response, at step 4-5, the authentication server 330 stores the token and associated biometric data for future use. For example, the authentication server 330 can send the token to a card issuer for storage in a vault for future use, which could allow for faster transactions. An example of future use (i.e. second financial transaction) is described below with reference to FIG. 5.

Notably, the client device 130 does not need to perform the authentication steps by the authentication server 330, such as sending the request for EMV data along with the card data (i.e. step 4-1), receiving and processing the EMV data to authenticate the EMV data using the terminal key (i.e. step 4-2), and generating and transmitting the biometric block (i.e. step 4-3). As previously explained, this can enhance security and flexibility for users.

FIG. 5 shows an example of processing a second financial transaction using the token that has been stored with the first financial transaction (see FIG. 4). A user selects to pay with their token on file. At step 5-1, upon determining that the token is available, the card data does not need to be entered again, and EMV authentication steps can be skipped as well. In this manner, one-touch checkout is enabled.

Authentication involves the user holding their fingerprint against the client device 130. The client device 130 obtains biometric data and sends the same to the authentication server 330. At step 5-2, the authentication server 330 receives the biometric data and generates a biometric block based on the biometric data. Furthermore, upon matching data (e.g. user login data and biometric data), the token is released from the vault and the authentication server 330 obtains the token. Then, the authentication server 330 sends the biometric block along with the token and a request for the second financial 5 transaction.

The token is used by networks to request payment with issuers and to determine who authorized payment. The second financial transaction is authorized by the financial gateway 530 if the biometric block is authentic in which case confirmation of authorization is sent to the authentication server 330. At step 5-3, upon receiving the confirmation of authorization, the authentication server 330 relays the same to the client device 130. At this point, the client device 130 can provide an indication to the user that payment is complete.

Notably, the client device 130 does not need to perform the authentication steps by the authentication server 330, such as obtaining the token upon matching data, and generating and sending the biometric block along with the token (i.e. step 5-2). As previously explained, this can enhance security and flexibility for users.

In some implementations, the authentication server 330 matches the biometric data of the second financial transaction to the biometric data of the first financial transaction. For example, the authentication server 330 can generate a first security key based on the biometric data of the first financial transaction, generate a second security key based on the biometric data of the second financial transaction, and compare the first security key to the second security key. Other implementations are possible.

It is noted that some examples described herein, including FIG. 4 and FIG. 5, refer to a “first financial transaction” and a “second financial transaction”. In particular, a token can be stored with the “first financial transaction” and subsequently used with the “second financial transaction”, such that the “second financial transaction” occurs after the “first financial transaction”. However, it is to be understood that this does not preclude other financial transactions occurring at other times, for example before the “first financial transaction” and/or in-between the “first financial transaction” and the “second financial transaction”.

FIG. 6 shows an example of processing a first financial transaction using manual entry of card data and authentication using a PIN, with a token storage process. A user selects to pay and enters card data, which is sent to the authentication server 330. At step 6-1, the authentication server 330 sends a request for EMV data along with the card data to the financial gateway 530 (e.g. VISA/MasterCard), which responds by generating EMV data and returning the same to the authentication server 330. At step 6-2, after the authentication server 330 receives the EMV data from the financial gateway 530, the authentication server 330 processes and authenticates the EMV data against a kernel using a terminal key. Furthermore, the authentication server 330 sends a request for authentication to the client device 130. The user can respond by entering a PIN, for example using a touchscreen of the client device 130, and the PIN is then sent to the authentication server 330.

At step 6-3, the authentication server 330 captures and isolates the PIN, generates a PIN block based on the PIN, and sends the PIN block along with a request for the first financial transaction. In response, the card network generates and issues a token based on the card data. The token is used by networks to request payment with issuers and to determine who authorized payment. The first financial transaction is authorized by the financial gateway 530 if the PIN block is authentic in which case confirmation of authorization and the token are sent to the authentication server 330.

At step 6-4, upon receiving the confirmation of authorization and the token, the authentication server 330 relays the same to the client device 130. At this point, the client device 130 can provide an indication to the user that payment is complete. If the user agrees to store the token for future use, then a response is sent to the authentication server 330. Upon receipt of the response, at step 6-5, the authentication server 330 stores the token and associated biometric data for future use. For example, the authentication server 330 can send the token to a card issuer for storage in a vault for future use, which could allow for faster transactions. An example of future use (i.e. second financial transaction) is described below with reference to FIG. 7.

Notably, the client device 130 does not need to perform the authentication steps by the authentication server 330, such as sending the request for EMV data along with the card data (i.e. step 6-1), receiving and processing the EMV data to authenticate the EMV data using the terminal key (i.e. step 6-2), and generating and transmitting the PIN block (i.e. step 6-3). As previously explained, this can enhance security and flexibility for users.

FIG. 7 shows an example of processing a second financial transaction using the token that has been stored with the first financial transaction (see FIG. 6). A user selects to pay with their token on file. At step 7-1, upon determining that the token is available, the card data does not need to be entered again, and EMV authentication steps can be skipped as well.

Authentication involves the user entering a PIN, for example using a touchscreen of the client device 130, and the PIN is then sent to the authentication server 330. At step 7-2, the authentication server 330 captures and isolates the PIN, and generates a PIN block based on the PIN. Furthermore, upon matching data (e.g. user login data and PIN block), the token is released from the vault and the authentication server 330 obtains the token. Then, the authentication server 330 sends the PIN block along with the token and a request for the second financial transaction.

The token is used by networks to request payment with issuers and to determine who authorized payment. The second financial transaction is authorized by the financial gateway 530 if the PIN block is authentic in which case confirmation of authorization is sent to the authentication server 330. At step 7-3, upon receiving the confirmation of authorization, the authentication server 330 relays the same to the client device 130. At this point, the client device 130 can provide an indication to the user that payment is complete.

Notably, the client device 130 does not need to perform the authentication steps by the authentication server 330, such as obtaining the token upon matching data, and generating and sending the PIN block along with the token (i.e. step 7-2). As previously explained, this can enhance security and flexibility for users.

In some implementations, the authentication server 330 matches at least a portion of the PIN block of the second financial transaction to the token from the first financial transaction. This is because the token includes a pathway to build the PIN block from the token's cryptogram. Note that the PIN block of the second financial transaction is not normally identical to the PIN block of the first financial transaction, even though they may share some identical data such as the PIN. This is because there is some dynamic components in the PIN block, such as an application transaction counter, and the sequencing information can differ. Other implementations are possible.

FIG. 8 shows an example of processing a first financial transaction using web-based NFC entry of card data and authentication using a PIN, with a token storage process. A financial transaction is initiated by a user with a web-based NFC/PIN online checkout. The user selects to pay and initiates a web-based NFC payment via web browser by holding their card against their client device 130, which is NFC-enabled. Information for the financial transaction (e.g. card data and purchase price) is then provided to the authentication server 330. Upon receiving that information, at step 8-1 the authentication server 330 authenticates the card or wallet against a kernel. With the web-based NFC entry of card data, EMV authentication steps can be skipped. Furthermore, the authentication server 330 sends a request for authentication to the client device 130. The user can respond by entering a PIN, for example using a touchscreen of the client device 130, and the PIN is then sent to the authentication server 330.

At step 8-2, the authentication server 330 captures and isolates the PIN, generates a PIN block based on the PIN, and sends the PIN block along with a request for the first financial transaction. In response, the card network generates and issues a token based on the card data. The token is used by networks to request payment with issuers and to determine who authorized payment. The first financial transaction is authorized by the financial gateway 530 if the PIN block is authentic in which case confirmation of authorization and the token are sent to the authentication server 330.

At step 8-3, upon receiving the confirmation of authorization and the token, the authentication server 330 relays the same to the client device 130. At this point, the client device 130 can provide an indication to the user that payment is complete. If the user agrees to store the token for future use, then a response is sent to the authentication server 330. Upon receipt of the response, at step 8-4, the authentication server 330 stores the token and associated biometric data for future use. For example, the authentication server 330 can send the token to a card issuer for storage in a vault for future use, which could allow for faster transactions. An example of future use (i.e. second financial transaction) is described below with reference to FIG. 9.

Notably, the client device 130 does not need to perform the authentication steps by the authentication server 330, such as authenticating the card or wallet against the kernel (i.e. step 8-1) and generating and transmitting the PIN block (i.e. step 8-2). As previously explained, this can enhance security and flexibility for users.

FIG. 9 shows an example of processing a second financial transaction using the token that has been stored with the first financial transaction (see FIG. 8). A user selects to pay with their token on file. At step 9-1, upon determining that the token is available, the web-based NFC entry of card data does not need to be repeated, and EMV authentication steps can be skipped as well.

Authentication involves the user entering a PIN, for example using a touchscreen of the client device 130, and the PIN is then sent to the authentication server 330. At step 9-2, the authentication server 330 captures and isolates the PIN, and generates a PIN block based on the PIN. Furthermore, upon matching data (e.g. user login data and PIN block), the token is released from the vault and the authentication server 330 obtains the token. Then, the authentication server 330 sends the PIN block along with the token and a request for the second financial transaction.

The token is used by networks to request payment with issuers and to determine who authorized payment. The second financial transaction is authorized by the financial gateway 530 if the PIN block is authentic in which case confirmation of authorization is sent to the authentication server 330. At step 9-3, upon receiving the confirmation of authorization, the authentication server 330 relays the same to the client device 130. At this point, the client device 130 can provide an indication to the user that payment is complete.

Notably, the client device 130 does not need to perform the authentication steps by the authentication server 330, such as obtaining the token upon matching data, and generating and sending the PIN block along with the token (i.e. step 9-2). As previously explained, this can enhance security and flexibility for users.

In some implementations, the authentication server 330 matches at least a portion of the PIN block of the second financial transaction to the token from the first financial transaction. This is because the token includes a pathway to build the PIN block from the token's cryptogram. Note that the PIN block of the second financial transaction is not normally identical to the PIN block of the first financial transaction, even though they may share some identical data such as the PIN. This is because there is some dynamic components in the PIN block, such as an application transaction counter, and the sequencing information can differ. Other implementations are possible.

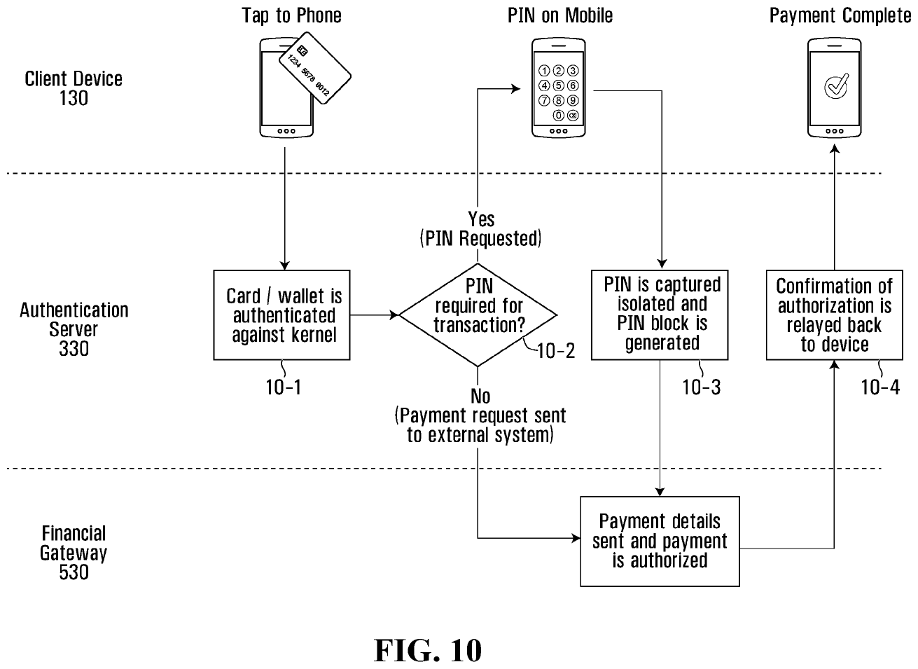

FIG. 10 shows an example of processing a financial transaction using a web-based NFC entry of card data and authentication using a PIN. A financial transaction is initiated by a user entering a charge into their client device 130, and then holding a card against the client device 130, which is NFC-enabled. Information for the financial transaction (e.g. card data and purchase price) is then provided to the authentication server 330. Upon receiving that information, at step 10-1 the authentication server 330 authenticates the card or wallet against a kernel.

At step 10-2, the authentication server 330 determines whether a PIN is required for the financial transaction. A PIN may be required depending on some criteria, for example the purchase price exceeding a given threshold such as $100 for example. If the authentication server 330 determines that a PIN is not required, then a payment request is sent to the financial gateway 530. However, if the authentication server 330 determines that a PIN is required, then a request is sent to the client device 130, and the user can respond by entering a PIN, for example using a touchscreen of the client device 130, and the PIN is then sent to the authentication server 330.

At step 10-3, the authentication server 330 captures and isolates the PIN, generates a PIN block based on the PIN and sends the PIN block to the financial gateway 530 (e.g. Gateway, processor, card network) along with a payment request. The financial transaction is authorized by the financial gateway 530 if the PIN block is authentic. After the payment request has been processed by the financial gateway 530, at step 3-4 the authentication server 330 receives a result of the payment request and relays that result to the client device 130. In this case, the result of the payment request is a confirmation of authorization, and hence the client device 130 can provide an indication to the user that payment is complete.

Notably, the client device 130 does not need to perform the authentication steps by the authentication server 330, such as authenticating the card or wallet against the kernel (i.e. step 10-1) and generating and transmitting the PIN block (i.e. step 10-3). As previously explained, this can enhance security and flexibility for users.

FIG. 10 is similar to FIG. 3. However, while FIG. 3 uses a web NFC framework via an HTML interface, FIG. 10 is based on a hardware client device such as a smartphone for example.

### Terminal Key Injection

As explained above with reference to FIG. 1, a terminal key can be generated and remotely “injected” into a financial transaction system for storage on an authentication server. With reference to FIG. 11, shown is a flowchart of a method for remote key injection. It is to be understood that FIG. 11 is very specific and is provided merely for illustrative purposes, and that other embodiments are possible and within the scope of this disclosure.

By way of overview, this method involves an authentication server 330 receiving a key from a key injection appliance, and storing the key in a key-box. The key can later be used for authentication purposes, for example when generating a PIN block for a financial transaction for example. Details of the method are provided below.

At step 11-1, the authentication server 330 receives an MID (Merchant ID) and a TID (Transaction ID). At step 11-2, the authentication server 330 confirms merchant on-boarding status.

At step 11-3, the authentication server 330 requests a terminal key from a key injection appliance API (Application Program Interface). The terminal key is assigned based on the MID and the TID. At step 11-4, the authentication server 330 receives the terminal key from the key injection appliance API and stores it within a key-box of the authentication server 330. The terminal key is a public security key, which is hidden within a database.

At step 11-5, a merchant or consumer initiates a payment process, examples of which have been described above. At step 11-6, the authentication server 330 performs payment and authenticates with the terminal key across the merchant's acceptance points or devices. The terminal key is associated with the transaction and can be used with many client devices. This enables one-to-many use (i.e. terminal key can be used with multiple client devices of the merchant) rather than one-to-one use (i.e. terminal key can be used with only one client device of the merchant). At step 11-7, the authentication server 330 completes the transaction with a response sent back to devices and apps.

Some implementations enable a one to many association for merchant keys to connected devices and apps. The merchant can have one key assigned to them but can have an unlimited number of applications and devices connected to them each passing payments via the same terminal which houses the merchant's key. This technology is an agnostic platform that can integrate with any gateway or processor.

### Example Software Architecture

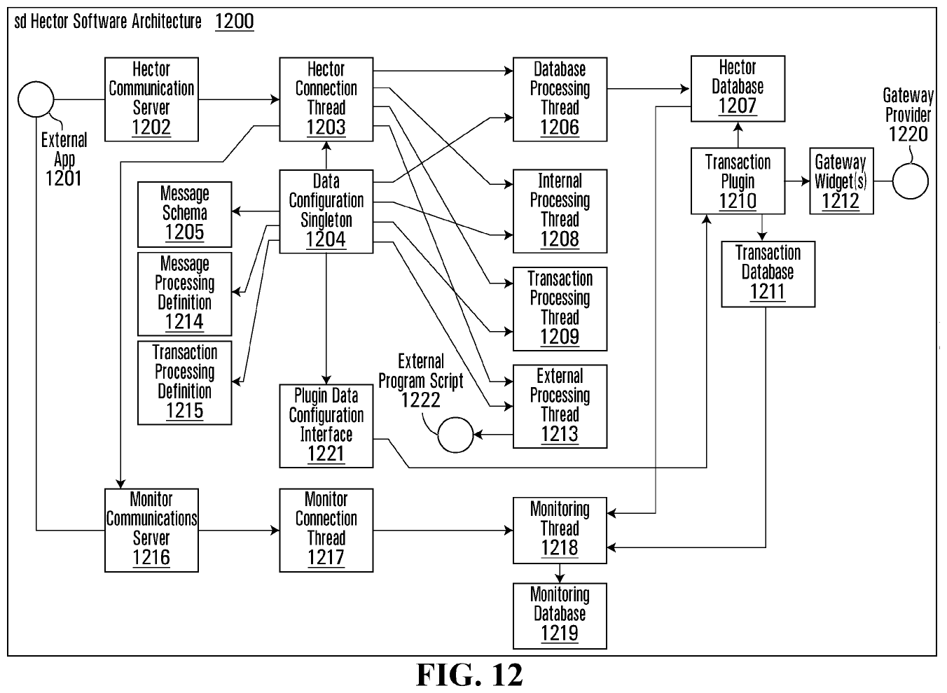

With reference to FIG. 12, shown is a block diagram of example software architecture for an authentication server, which is referred to as “Hector”. It is to be understood that FIG. 12 is very specific and is provided merely for illustrative purposes, and that other embodiments are possible and within the scope of this disclosure.

Hector is a message processing engine. Hector has a set of messages definitions and a set of predefined processing definitions. Once this configuration is defined, Hector can accept incoming messages from a valid source and then process the message to achieve a result. In some implementations, Hector supports the following processing methods as a minimum:
Database Queries
Internal Processing
Transactions

### Software Development Environment

In some implementations, Hector is developed using the C++ Language. In some implementations, the development of Hector makes use of the QT API, as this allows for platform independent development. This means that hector can be deployed in either Windows, Linux or IOS environments.

### Database Development Environment

In some implementations, Hector makes use of an MS SQL database for data storage and data processing. In some implementations, the Database for Hector is MS SQL Server 2018.

### Software Architecture

FIG. 12 gives an overview of Hector's software architecture 1200. In some implementations, as Hector functions primarily as a message processing engine, its architecture 1200 is designed to facilitate this primary function. Therefore, in some implementations, Hector has one communication interface for accepting messages from external applications and a second which it uses to monitor the system. The following subsections will provide an overview of the function associated with each element in the architecture.

### Software Architecture: Communications Server

In some implementations, the communication server 1202 is responsible for monitoring communication requests and monitoring for the loss of connection. In some implementations, when a connection request is received, and the communication channel has been secured the server will create a connection thread to handle all subsequent communications. In some implementations, the same thread is never used twice (e.g. each thread in every process is unique and single use only with a different IP and handshake authentication).

The connection thread 1203 processes the messages received from the external app 1201. For this thread to perform its functionality, the Data Configuration Singleton 1204 has to have been created. On receipt of a message the connection thread 1203 will validate the message structure against the message schema 1205, the thread will send a response to the external app 1201 on the validity of the message. Once the message is determined to be valid, the connection thread 1203 will determine how the message is to be processed, passing the processing of the message to the appropriate processing thread. At this point, it will wait for a processing result which it will then return to the external app 1201.

The Database Processing Thread 1206 is created by the Connection Thread 1203 once a message has been identified as being a database processing message. This thread will take the message data and use it to create a SQL query for the message as defined in the Database Processing Definition Configuration Data. After sending the query to the database the thread will wait from the query result. On receipt of the query result, the thread will build a message result and return it to the connection thread 1203 before closing.

The Hector database 1207 is configured with all the tables used by Hector to facilitate data requests from the external application 1201. Access to the database 1207 is only through sending valid SQL Queries. Any invalid query will not return valid data to the data processing thread 1206.

The Internal Processing Thread 1208 is created by the Connection Thread 1203 once a message has been identified as being an internal processing message. This thread 1208 will take the message data and build a result based on the internal processing requested. The types of internal functions that will be available through this thread are date, time, etc. Once the thread has built and sent the result to the connection thread, this thread will exit.

The Transaction Processing Thread 1209 is created by the Connection Thread 1203 once a message has been identified as being a transaction processing message. This thread will take the message data and initiate the Transaction Plugin 1210 which will perform all the steps associated with performing a transaction. The thread will wait for a result from the plugin, the result will then be returned to the Connection Thread 1203 before this thread exits.

The Transaction Plugin 1210 is intended to handle all the transaction processing functionality for the external application 1201. A plugin is used to isolating the transaction processing from the core functionality of hector, as this is an ever changing entity tied to how financial institutes update and revise their method of transaction processing.

The Transaction Database 1211 is configured with all the tables used by Hector to do transaction processing. It is isolated from the Hector Database 1207 for security reasons, but it is accessed in the same way.

Gateway Widget(s) 1212 are used to access a specific gateway provider 1220. Each one can be customized based on the specific interface details for the provider. This method is transparent to the user and the external application has the Transaction Plugin 1210 formats the data as appropriate for the provider.

The External Processing Thread 1213 is created by the Connection Thread 1203 once a message has been identified as being an external processing message. This thread will take the message data and determine the method of external processing as appropriate involving an external program/script 1222. It is expected that external processing will support php scripts, perl scripts, javascript and command line executables. Once the external processing is determined and called, the thread will wait for a result for the external processing. On receipt of the result the thread will generate a result and return it to the connection thread, before exiting.

### Software Architecture: Data Configuration Singleton

There is a singleton class 1204 that holds all the static configuration data for Hector, it is loaded into memory when hector starts and can be accessed by any Hector thread as appropriate.

The Message Schema 1205 is an XML schema file that contains the definition of all messages used by hector. The schema itself is validated for correctness at time of loading into memory.

The Message Processing Definition 1214 is an XML Configuration file that is used to determine how a received message is to the processed and what data within the message is used for processing.

The Transaction Processing Definition 1215 is an XML Configuration file that is used to determine what internal data is used by a gateway provider and how it is to be structured for sending a message through to the gateway.

The Database Processing Definition is an XML configuration file that is used to translate incoming messages to a SQL query and then SQL responses back into a response message.

### Software Architecture: Plugin Data Configuration Interface.

The Data Configuration singleton 1204 cannot be accessed directly by a plugin. Thus, for all the plugin access to the data, a plugin interface class 1221 is generated from the Data Configuration Singleton 1204 allowing a hector plugin indirect access to the configuration data.

### Software Architecture: Monitor Communications Server

The monitoring communication thread 1216 is used to allow connections from the external app and internal threads for the purposes of monitoring and reporting on the health and security of the system. On connection the server will create a Monitor Connection Thread.

The Monitor Connection Thread 1217, once created, will check the message received for validity before creating a Monitoring Thread to process the message.

The Monitoring Thread 1218 will process the message received and perform the appropriate action associated with the message. This thread will form the bases of the attestation monitoring for hector and the external app.

The Monitoring Database 1219 will record all the data associated with the monitoring of hector and the external app. The data within the database can be used to generate the attestation reporting guidelines.

### Example Sequence Drawings

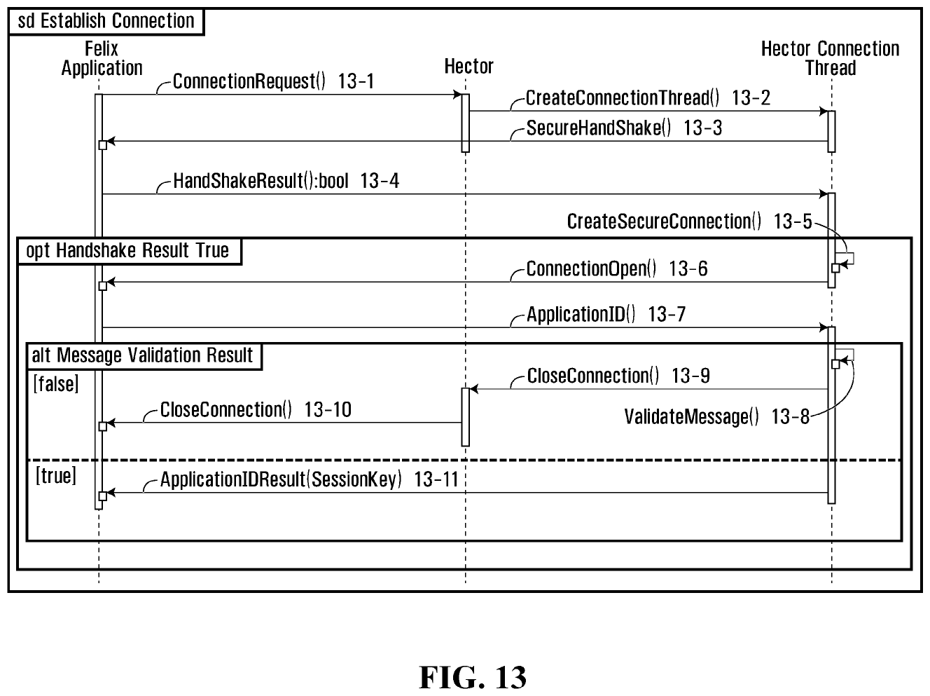

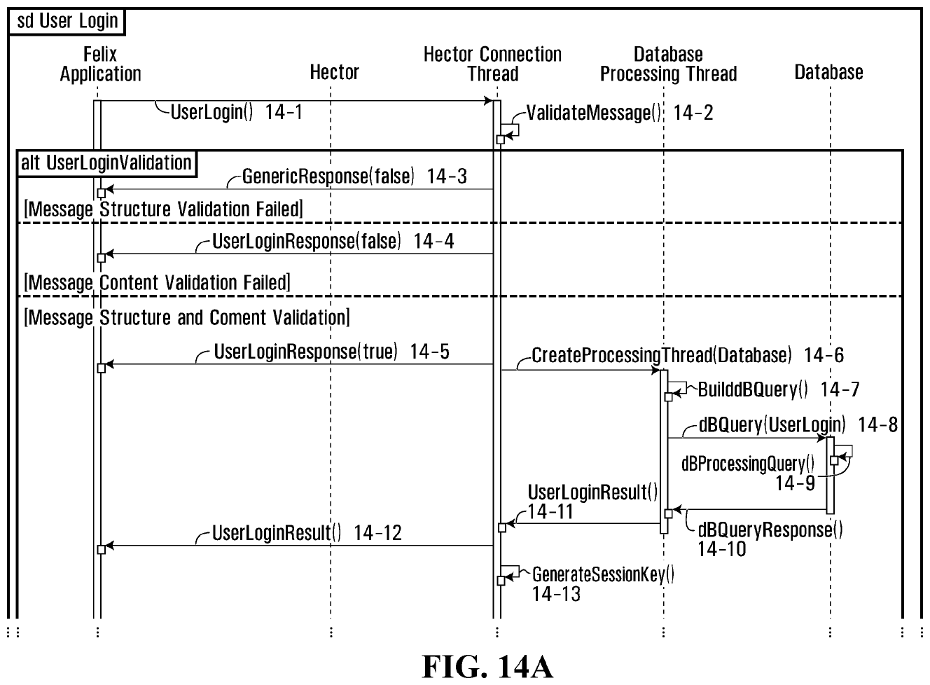

With reference to FIG. 13 through FIG. 22, shown are sequence drawings showing example signaling and processing for a financial transaction system. These sequence drawings show interaction between a Felix SDK (client device) and Hector (authentication server) as described in further detail below. It is to be understood that FIG. 13 through FIG. 22 are very specific and are provided merely for illustrative purposes, and that other embodiments are possible and within the scope of this disclosure.

Establish Connection

The following describes in detail the sequence represented in FIG. 13:
Step 13-1: The Felix Application will request a connection to Hector
Step 13-2: Hector will create a connection thread
Step 13-3: Hector will return a secure handshake response to the Felix Application
Step 13-4: The Felix Application will confirm this result (Handshake Result is True) with Hector
Assuming the Handshake Result is True:
   Steps 13-5 & 13-6: Hector will create a secure connection with the Felix Application
   Steps 13-7 & 13-8: The Felix Application will respond with an ApplicationID
If the Handshake Result is False:
   Step 13-9: The Hector connection thread will close the connection with Hector
   Step 13-10: Hector will close the connection with the Felix Application
Step 13-11: If the Handshake Result was True above, the Hector connection thread will return the applicationIDResult (the session key) to the Felix Application and the connection is established

### User Login

The following describes in detail the sequence represented in FIG. 14:
Step 14-1: The Felix Application will send user login details via Hector to establish a Hector connection thread
Step 14-2: The Hector connection thread will validate the message, returning three possible outcomes—Generic response of False, user login response of false or user login response of True
Step 14-3: If the response is a generic response of False, a general error message of message structure validation failed will be returned via the Felix Application and this process ends
Step 14-4: If the response is user login response is False, an error message of message content validation failed will be returned via the Felix Application and this process ends
Step 14-5: If the response is user login response is True, a success message will be returned via the Felix Application and the process continues
Step 14-6: The Hector connection thread will now create a processing thread with the Hector Database Processing Thread
Step 14-7: Hector Database Processing Thread will build the Database query (DBQuery)
Step 14-8: Hector Database Processing Thread will send the DBQuery to the Database with User Login details
Steps 14-9 & 14-10: The Database will process the query and return the response to the Hector Database Processing Thread
Step 14-11: Hector Database Processing Thread will return the login result to the Hector Connection Thread
Step 14-12: The Hector Connection Thread will return this login result to the Felix Application via Hector
Step 14-13: The Hector Connection Thread will generate a session key for the database query
Step 14-14: The Hector Connection Thread will build the database query
Step 14-15: The Hector Connection Thread will send the database query to the Database with the session key
Steps 14-16 & 14-17: The Database will process the query and send the database query response to the Hector Connection Thread
Step 14-18: The Hector Connection Thread will send the Session Key Details back to Hector

### Initiate Transaction

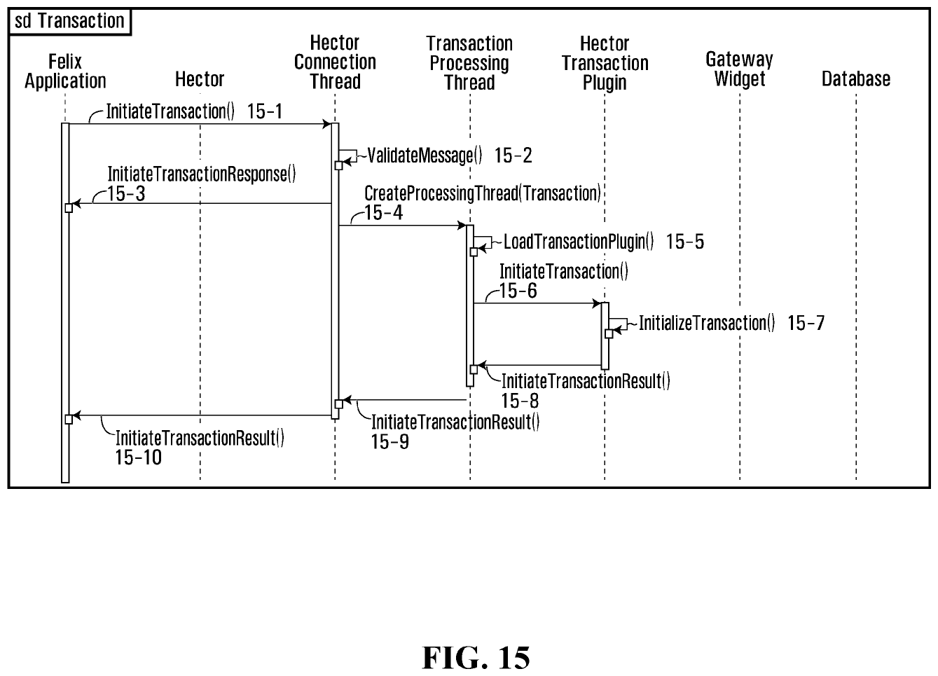

The following describes in detail the sequence represented in FIG. 15:
Step 15-1: The Felix Application will send a request to initiate a transaction via Hector to the Hector Connection Thread
Steps 15-2 & 15-3: The Hector Connection Thread will validate the message and send a response back to the Felix Application via Hector
Step 15-4: The Hector Connection Thread will then create a processing thread for the transaction by calling the Transaction Processing Thread
Step 15-5: The Transaction Processing Thread will load the plugin for the transaction
Step 15-6: The Transaction Processing Thread will then initiate the transaction with the Hector Transaction Plugin
Steps 15-7 & 15-8: The Hector Transaction Plugin will initialize the transaction and will send a response to the Transaction Processing Thread
Steps 15-9 & 15-10 The Transaction Processing Thread will return this result to the Hector Connection Thread, which will in turn send this response to the Felix Application via Hector

### Tag Details

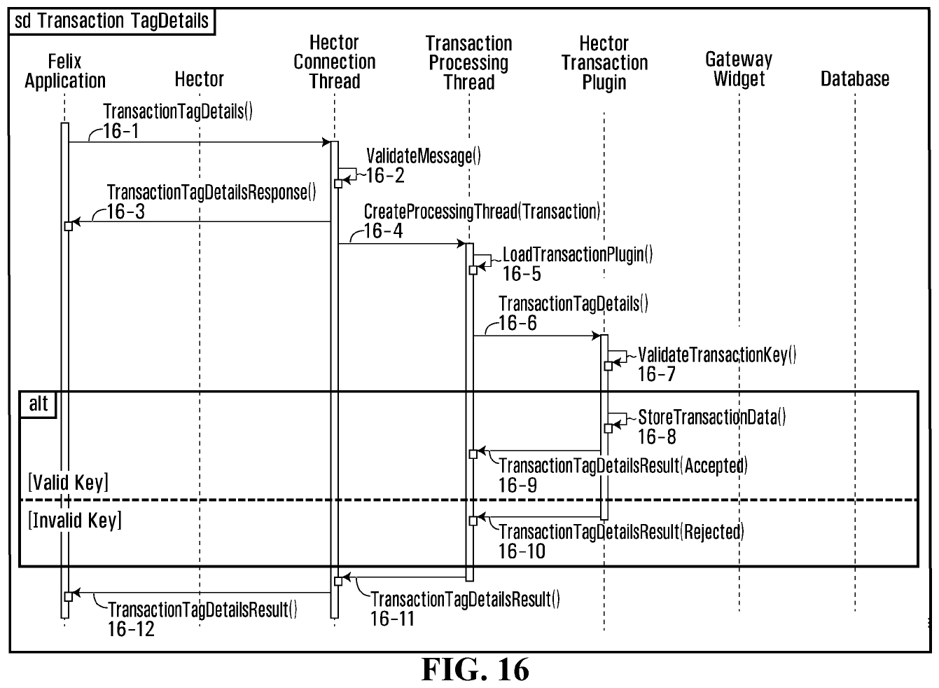

The following describes in detail the sequence represented in FIG. 16:
Step 16-1: The Felix Application will send transaction details to the Hector Connection Thread via Hector
Step 16-2: The Hector Connection Thread will validate the message
Step 16-3: The Hector Connection Thread will send the response to the Felix Application via Hector
Step 16-4: The Hector Connection Thread will create a processing thread via the Transaction Processing Thread
Steps 16-5 & 16-6: The Transaction Processing Thread will load the transaction plugin module and send transaction tag details
Step 16-7: The Hector Transaction Plugin will validate the transaction key
If the transaction key is valid:
   Step 16-8: The Hector Transaction Plugin will store the transaction data
   Step 16-9: The Hector Transaction Plugin will return the transaction tag details result as True/Accepted
If the transaction key is not valid:
   Step 16-10: The Hector Transaction Plugin will return the transaction tag details result as False/Rejected
Step 16-11: The Hector Processing Thread will return the transaction tag details result to the Hector Connection Thread
Step 16-12: The Hector Connection Thread will then return the transaction tag details result to the Felix Application via Hector

### PIN Details

The following describes in detail the sequence represented in FIG. 17:
Step 17-1: The Felix Application will send transaction details to the Hector Connection Thread via Hector
Step 17-2: The Hector Connection Thread will validate the message
Step 17-3: The Hector Connection Thread will send the response to the Felix Application via Hector
Step 17-4: The Hector Connection Thread will create a processing thread via the Transaction Processing Thread
Steps 17-5 & 17-6: The Transaction Processing Thread will load the transaction plugin module and send transaction tag details
Step 17-7: The Hector Transaction Plugin will validate the transaction key
If the transaction key is valid:
   Step 17-8: The Hector Transaction Plugin will store the transaction data
   Step 17-9: The Hector Transaction Plugin will return the transaction tag details result as True/Accepted to the Hector Processing Thread
   Step 17-10: The Hector Processing Thread will pass this response back to the Hector Connection Thread
   Step 17-11: The Hector Connection Thread will pass this response back to the Felix Application via Hector
If the transaction key is not valid:
   Step 17-12: The Hector Transaction Plugin will return the transaction tag details result as False/Rejected
   Step 17-13: The Hector Processing Thread will return the transaction tag details result to the Hector Connection Thread
   Step 17-14: The Hector Connection Thread will then return the transaction tag details result to the Felix Application via Hector

### Signature Details

The following describes in detail the sequence represented in FIG. 18:
Step 18-1: The Felix Application will send transaction sign details to the Hector Connection Thread via Hector
Step 18-2: The Hector Connection Thread will validate the message
Step 18-3: The Hector Connection Thread will send the transaction sign response to the Felix Application via Hector
Step 18-4: The Hector Connection Thread will create a processing thread via the Transaction Processing Thread
Step 18-5 & 18-6: The Transaction Processing Thread will load the transaction plugin module and send transaction tag details
Step 18-7: The Hector Transaction Plugin will validate the transaction key
If the transaction key is valid:
   Step 18-8: The Hector Transaction Plugin will store the transaction data
   Step 18-9: The Hector Transaction Plugin will return the transaction sign details result as True/Accepted
If the transaction key is not valid:
   Step 18-10: The Hector Transaction Plugin will return the transaction sign details result as False/Rejected
Step 18-11: The Hector Processing Thread will return the transaction sign details result to the Hector Connection Thread
Step 18-12: The Hector Connection Thread will then return the transaction sign details result to the Felix Application via Hector

### Process

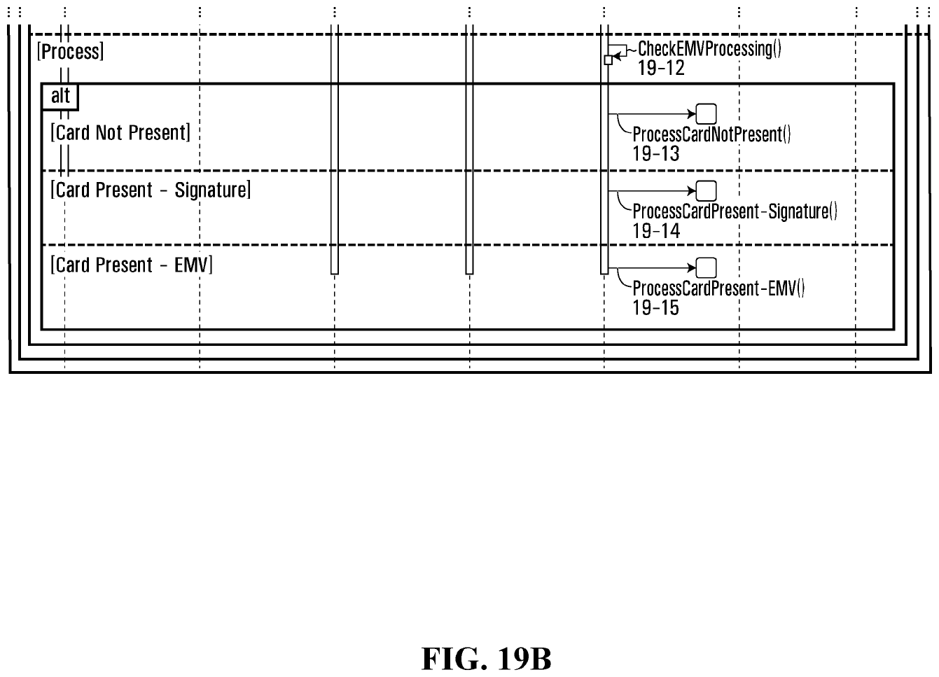

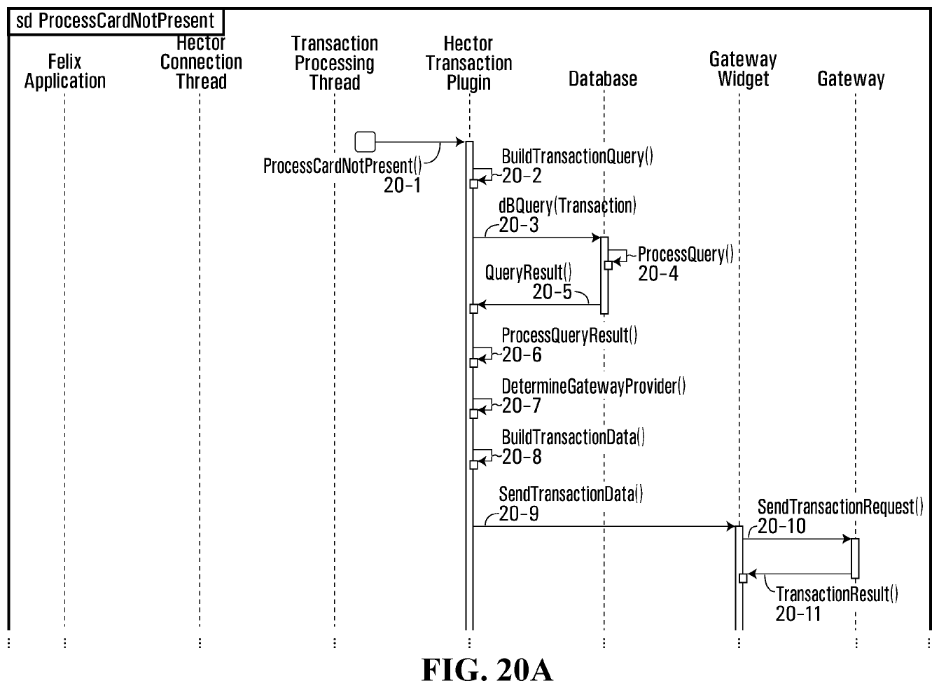

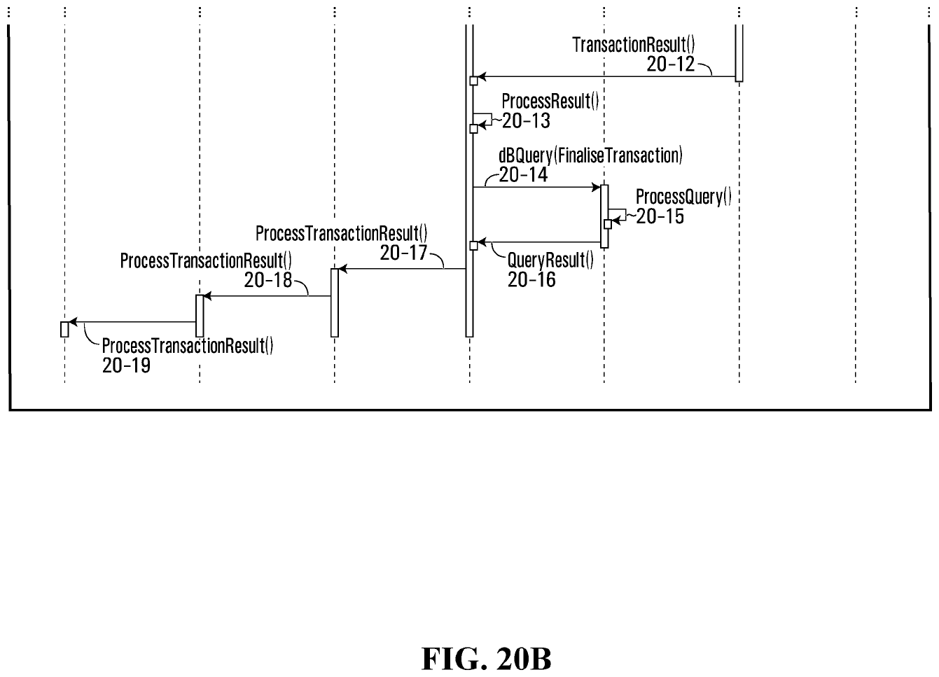

The following describes in detail the sequence represented in FIG. 19:
Step 19-1: The Felix Application will send a process transaction request to the Hector Connection Thread via Hector
Step 19-2: The Hector Connection Thread will validate the message
Step 19-3: The Hector Connection Thread will send the process transaction response to the Felix Application via Hector
Step 19-4: The Hector Connection Thread will create a processing thread (type transaction) via the Transaction Processing Thread
Steps 19-5 & 19-6: The Transaction Processing Thread will load the transaction plugin module and send a process transaction request to the Hector Transaction Plugin
Step 19-7: The Hector Transaction Plugin will validate the transaction key
Step 19-8: If the transaction key is invalid the Hector Transaction Plugin will send a result of False/Rejected to the Hector Processing Thread
If the transaction key is valid:
   Step 19-9: The Hector Transaction Plugin will check the process flag
   If the flag is set to Cancel Transaction
      Steps 19-10 & 19-11: The Hector Transaction Plugin will cancel the transaction send the response back to the Transaction Processing Thread
   If the flag is set to Process Transaction the Hector Transaction Plugin will check EMV Processing (step 19-12) and call one of three processes:
      Step 19-13: Process as Card Not Present (see FIG. 20)
      Step 19-14: Process as Card Present—Signature (see FIG. 21)
      Step 19-15: Process ad Card Present— EMV (see FIG. 22)

### Card Not Present

The following describes in detail the sequence represented in FIG. 20:
Step 20-1: The Hector Transaction Plugin will receive a request to process a transaction as Card Not Present
Step 20-2: The Hector Transaction Plugin will build the transaction query
Step 20-3: The Hector Transaction Plugin will send the dbquery (type transaction) to the Database
Step2 20-4 & 20-5: The Database will process the query and will return the query result
Step 20-6: The Hector Transaction Plugin will then process the query result
Step 20-7: The Hector Transaction Plugin will determine the Gateway Provider
Step 20-8: The Hector Transaction Plugin will build the transaction data
Step 20-9: The Hector Transaction Plugin will then send the transaction data to the Gateway Widget
Step 20-10: The Gateway Widget will send a request to process the transaction data to the appropriate Gateway
Step 20-11: The Gateway will process the transaction and send the result to the Gateway Widget
Step 20-12: The Gateway Widget will send this result to the Hector Transaction Plugin
Step 20-13: The Hector Transaction Plugin will process this result
Step 20-14: The Hector Transaction Plugin will send a request to the Database to process the query
Steps 20-15 & 20-16: The Database will send the result of the query back to the Hector Transaction Plugin
Step 20-17: The Hector Transaction Plugin will then send this result back to Transaction Processing Thread
Step 20-18: The Transaction Processing Thread will then send this result back to the Hector Connection Thread
Step 20-19: The Hector Connection Thread will send the result of processing with Card Not Present back to the Felix Application

### Signature

The following describes in detail the sequence represented in FIG. 21:
Step 21-1: The Hector Transaction Plugin will receive a request to process a transaction as Card Present—Signature
Step 21-2: The Hector Transaction Plugin will check if signature data is available
If signature data is available:
   Steps 21-3 & 21-4: The Hector Transaction Plugin will send the dbquery (type transaction) to the Database
   Steps 21-5 & 21-6: The Database will process the query and will return the query result
   Step 21-7: The Hector Transaction Plugin will then process the query result
   Step 21-8: The Hector Transaction Plugin will determine the Gateway Provider
   Step 21-9: The Hector Transaction Plugin will build the transaction data
   Step 21-10: The Hector Transaction Plugin will then send the transaction data to the Gateway Widget
   Step 21-11: The Gateway Widget will send a request to process the transaction data to the appropriate Gateway
   Step 21-12: The Gateway will process the transaction and send the result to the Gateway Widget
   Step 21-13: The Gateway Widget will send this result to the Hector Transaction Plugin
   Step 21-14: The Hector Transaction Plugin will process this result
   Step 21-15: The Hector Transaction Plugin will send a request to the Database to process the query
   Steps 21-16 & 21-17: The Database will process the query and will send the result of the query back to the Hector Transaction Plugin
If signature data is not available:
   Step 21-18: The Hector Transaction Plugin will process Transaction as cancelled
Step 21-19: The Hector Transaction Plugin will then send this result back to the Transaction Processing Thread
Step 21-20: The Transaction Processing Thread will send the result of processing to the Hector Connection Thread
Step 21-21: The Hector Connection Thread will send this result back to the calling Felix Application

### EMV & PIN

The following describes in detail the sequence represented in FIG. 22:
Step 22-1: The Hector Transaction Plugin will receive a request to process a transaction as Card Present—EMV
Step 22-2: The Hector Transaction Plugin will check if tag data is available
Step 22-3: The Hector Transaction Plugin will check if PIN data is available
If PIN data is present:
   Step 22-4: The Hector Transaction Plugin will process the tag data
   Step 22-5: The Hector Transaction Plugin will build the transaction query
   Step 22-6: The Hector Transaction Plugin will send the dbquery (type transaction) to the Database
   Steps 22-7 & 22-8: The Database will process the query and will return the query result
   Step 22-9: The Hector Transaction Plugin will then process the query result
   Step 22-10: The Hector Transaction Plugin will determine the Gateway Provider
   Step 22-11: The Hector Transaction Plugin will build the transaction data details
   Step 22-12: The Hector Transaction Plugin will then send the transaction data to the Gateway Widget
   Step 22-13: The Gateway Widget will send a request to process the transaction data to the appropriate Gateway
   Step 22-14: The Gateway will process the transaction and send the result back to the Gateway Widget
   Step 22-15: The Gateway Widget will send this result to the Hector Transaction Plugin
   Step 22-16: The Hector Transaction Plugin will process this result
   Step 22-17: The Hector Transaction Plugin will send a request to the Database to finalise the transaction
   Step 22-18 & 22-19: The Database will process the query and will return the result of finalising the transaction to the Hector Transaction Plugin
If PIN data is not present:
   Step 22-20: The Hector Transaction Plugin will call for processing as a Card Present & PIN transaction
If tag data is not available:
   Step 22-21: The Hector Transaction Plugin will process Transaction as cancelled
   Step 22-22: The Hector Transaction Plugin will then send this result back to the Transaction Processing Thread
   Step 22-23: The Transaction Processing Thread will send the result of processing to the Hector Connection Thread
   Step 22-24: The Hector Connection Thread will send this result back to the calling Felix Application

Numerous modifications and variations of the present disclosure are possible in light of the above teachings. It is therefore to be understood that within the scope of the appended claims, the disclosure may be practised otherwise than as specifically described herein.

1. A method for execution by an authentication server, comprising:
receiving, from a client device, information for a financial transaction;
executing in a kernel-based environment at least one authentication step based on the information; and
transmitting, to a financial gateway, a request for the financial transaction.

2. The method of claim 1, wherein:
receiving information comprises receiving personal identification data; and
executing at least one authentication step comprises generating a personal identification block based on the personal identification data and additional information, and transmitting the personal identification block to the financial gateway.

3. The method of claim 2, wherein the personal identification data comprises a PIN (personal identification number), and the personal identification block comprises a PIN block.

4. The method of claim 2, wherein the personal identification data comprises biometric data, and the personal identification block comprises a biometric block.

5. The method of claim 2, wherein the request for the financial transaction and the personal identification block are transmitted together in a single message.

6. The method of claim 2, wherein the additional information for the personal identification block comprises a terminal key.

7. The method of claim 6, wherein:
receiving information further comprises receiving user login details; and
the terminal key is retrieved from a database using the user login details.

8. The method of claim 7, wherein the authentication server is a first server and the database is stored on a second server separate from the first server.

9. The method of claim 6, wherein the additional information for the personal identification block further comprises a card certificate and sequencing information.

10. The method of claim 9, comprising:
acquiring the card certificate from a card issuer and generating the sequencing information.

11. The method of claim 6, wherein:
receiving information further comprises receiving card data; and
executing at least one authentication step further comprises:
sending the card data to the financial gateway;
receiving EMV (Europay, Mastercard and Visa) data from the financial gateway responsive to the card data; and
processing the EMV data and authenticating the EMV data using the terminal key.

12. The method of claim 11, wherein receiving the EMV data comprises receiving data that has been compressed by an intermediate node.

13. The method of claim 11, comprising:
receiving, from the financial gateway, a token generated by the financial gateway based on the card data; and
providing the token to a card issuer for storage in a vault for future use.

14. The method of claim 2, wherein a token previously generated based on card data is stored in a vault of a card issuer, and wherein:
executing at least one authentication step further comprises matching current data for the transaction against previously stored data, releasing and obtaining the token from the vault, and transmitting the token to the financial gateway.

15. The method of claim 14, wherein matching the current data against the previously stored data comprises:
matching current user login data against previously stored login data; and/or
matching the personal identification data against previously stored personal identification data.

16. The method of claim 14, wherein executing at least one authentication step further comprises comparing the personal identification block to the token.

17. The method of claim 14, wherein the request for the financial transaction, the personal identification block, and the token are all transmitted together in a single message.

18. The method of claim 1, wherein:
receiving information comprises receiving user login details and card data; and
executing at least one authentication step comprises:
retrieving a terminal key from a database using the user login details;
sending the card data to the financial gateway;
receiving EMV (Europay, Mastercard and Visa) data from the financial gateway responsive to the card data; and
processing and authenticating the EMV data using the terminal key.

19. The method of claim 18, wherein receiving the EMV data comprises receiving data that has been compressed by an intermediate node.

20. The method of claim 1, further comprising:
receiving an encryption key from the client device;
verifying, based on the encryption key, that the client device may operate with the authentication server.

21. The method of claim 1, further comprising:
receiving, from the financial gateway, a result of the financial transaction; and
transmitting, to the client device, the result of the financial transaction.

22. A non-transitory computer readable medium having recorded thereon statements and instructions that, when executed by a processor of an authentication server, implement the method of claim 1.

23. An authentication server comprising means for implementing the method of claim 1.

24. An authentication server comprising:
a network adapter;
authentication circuitry coupled to the network adapter and configured to:
receive, from a client device via the network adapter, information for a financial transaction;
execute in a kernel-based environment at least one authentication step based on the information; and
transmit, to a financial gateway via the network adapter, a request for the financial transaction.

25. The authentication server of claim 24, wherein the authentication circuitry is configured to receive a PIN (personal identification number) from the client device via the network adapter, generate a PIN block based on the PIN and additional information, and transmit the PIN block to the financial gateway via the network adapter.

26. The authentication server of claim 24, wherein the authentication circuitry is configured to receive biometric data from the client device via the network adapter, generate a biometric block based on the biometric data and additional information, and transmit the biometric block to the financial gateway via the network adapter.

27. The authentication server of claim 24, wherein the authentication circuitry is configured to:
receive, from the client device via the network adapter, user login details and card data;
retrieve a terminal key from a database using the user login details;
send, to the financial gateway via the network adapter, the card data;
receive, from the financial gateway via the network adapter, EMV (Europay, Mastercard and Visa) data responsive to the card data; and
process and authenticate the EMV data using the terminal key.

28. The authentication server of claim 24, wherein:
the authentication circuitry comprises a processor; and
the authentication server further comprises a non-transitory computer readable medium having recorded thereon statements and instructions that, when executed by the processor, configures the processor as the authentication circuitry.

29. A method for execution by a compression node, comprising:
receiving EMV (Europay, Mastercard and Visa) data from a financial gateway;
compressing the EMV data to produce compressed EMV data; and
transmitting the compressed EMV data to an authentication server.

30. The method of claim 29, wherein transmitting the compressed EMV data comprises:
transmitting first compressed data used for authentication before transmitting second compressed data that is not used for authentication.

31. The method of claim 30, wherein the first compressed data comprises at least one of EMV card aid, EMV card track, and EMV dynamic data.

32. The method of claim 30, comprising:
determining an order for the compressed EMV data by prioritizing the first compressed data ahead of the second compressed data.

33. A non-transitory computer readable medium having recorded thereon statements and instructions that, when executed by a processor of a compression node, implement the method of claim 29.

34. A compression node comprising means for implementing the method of claim 29.

35. A compression node comprising:
a network adapter;
compression circuitry coupled to the network adapter and configured to:
receive, from a financial gateway via the network adapter, EMV (Europay, Mastercard and Visa) data;
compress the EMV data to produce compressed EMV data; and
transmit, to an authentication server via the network adapter, the compressed EMV data.

36. The compression node of claim 35, wherein the compression circuitry is configured to transmit the compressed EMV data by transmitting first compressed data used for authentication before transmitting second compressed data that is not used for authentication.
